(19) United States
(12) Patent Application Publication
(10) Pub. No.: US 2011/0207956 A1
(43) Pub. Date: Aug. 25, 2011

(54) INTRAMOLECULAR C-H AMINATION WITH PHOSPHORYL AZIDES

(76) Inventors: X. Peter Zhang, Tampa, FL (US); Hongjian Lu, Tampa, FL (US)

(21) Appl. No.: 13/033,969

(22) Filed: Feb. 24, 2011

Related U.S. Application Data
(60) Provisional application No. 61/307,815, filed on Feb. 24, 2010.

(51) Int. Cl. C07F 9/6584

(52) U.S. Cl. 558/81

(57) ABSTRACT

A highly effective Co(II)-based system has been developed for catalytic intramolecular C—H amination with phosphoryl azides without the need of terminal oxidant or other additives, resulting in the high-yielding production of cyclophosphoramidates with nitrogen gas as the by-product; additional features of this new catalytic system include the amination of primary C—H bonds and formation of 7-membered ring structures.

### CROSS-REFERENCE TO RELATED APPLICATIONS

The present application claims the benefit of U.S. Provisional Application Ser. No. 61/307,815, filed Feb. 24, 2010, which is hereby incorporated by reference herein in its entirety.

### STATEMENT OF GOVERNMENT RIGHTS

This invention was made with Government support under grant number NSF #0711024, awarded by the National Science Foundation, Division of Chemistry. The Government has certain rights in the invention.

### FIELD OF THE INVENTION

The present invention generally relates to an environmentally benign and economically attractive catalytic process that allows preparation of value-added nitrogen compounds from readily available hydrocarbons.

### BACKGROUND OF THE INVENTION

Metal-catalyzed C—H amination via nitrene insertion constitutes a general strategy for the direct functionalization of C—H bonds with potential control of selectivities. The past decade has witnessed enormous progress in intramolecular C—H amination, as a direct result of the successful employment of dimeric Rh(II)₂-based catalysts in combination of various types of iminoiodane nitrene sources that can be generated in situ with terminal oxidants. Notable examples include Rh(II)₂-catalyzed intramolecular oxidative C—H amination of carbamates and sulfamates, generating synthetically valuable 5- and 6-membered heterocycles, respectively. In addition to substrate design, the continued success of this potentially far-reaching catalytic approach demands further development of effective metal catalysts as well as suitable nitrene sources. See, e.g., Muller et al., Chem. Rev. 2003, 103, 2905; Halfen et al., Curr. Org. Chem. 2005, 9, 657; Davies et al., Angew. Chem. Int. Ed. 2005, 44, 3518; Espino et al., in Modern Rhodium-Catalyzed Organic Reactions; Evans, P. A., Ed.; Wiley-VCH; Weinheim, 2005; pp 379-416; Davies et al., Angew. Chem. Int. Ed. 2006, 45, 6422; and Davies et al., Nature 2008, 451, 417. For early examples of in situ iminoiodane generation for catalytic nitrene transfers, see: (a) Yu et al., Org. Lett. 2000, 2, 2233; Dauban et al., J. Am. Chem. Soc. 2001, 123, 7707; and Espino et al., Angew. Chem. Int. Ed. 2001, 40, 598. For select examples, see: Espino et al., J. Am. Chem. Soc. 2001, 123, 6935; Cui et al., Chem. Int. Ed. 2004, 43, 4210; Fruit et al., Helv. Chim. Acta 2004, 87, 1607; Li et al., J. Org. Chem. 2006, 71, 5876; Reddy et al., Org. Lett. 2006, 8, 5013; Huard et al., Chem. Eur. J. 2008, 14, 6222; and Zalatan et al., J. Am. Chem. Soc. 2008, 130, 9220.

As a broad class of compounds that can be readily accessed via straightforward synthesis, azides have the potential to serve as a general type of alternative nitrene sources for metal-catalyzed C—H amination. Scriven et al., Chem. Rev. 1988, 88, 297; and Base et al., Angew. Chem. Int. Ed. 2005, 44, 5188. In addition to their wide availability, amination processes with azides can proceed under neutral conditions without the need of a terminal oxidant or base, while generating nitrogen gas as the only byproduct. Katsuki, Chem. Lett. 2005, 1304; and Cenini et al., Coord. Chem. Rev. 2006, 250, 1234. In spite of these potential advantages, only a few metal complexes have been recognized as effective catalysts for the decomposition of azides for C—H amination. See, Cenini et al., Chem. Commun. 2000, 2265; Ragaini et al., Chem. Eur. J. 2003, 9, 249; Lu et al., Organometallics ÅSAP Dec. 22, 2009 (DOI: 10.1021/om900916g); Ruppel et al., Org. Lett. 2007, 9, 4889; Badiei et al., Angew. Chem. Int. Ed. 2008, 47, 9961; Stokes et al., J. Am. Chem. Soc. 2007, 129, 7500; and Shen et al., Angew. Chem. Int. Ed. 2008, 47, 5056. They include the recently reported intermolecular (Co/aryl and carbonyl a azides; Cu/adamantyl azide) and intramolecular (Co/arylphosphorylazide; Rh₂/vinyl and aryl azides) systems.

Phosphoryl azides represent a common class of compounds and have been previously employed by Breslow and coworkers to generate phosphoryl nitrenes via photolysis for studying photochemical reactions. For example, the commercially available, low cost diphenylphosphoryl azide (DPPA) is a stable and distillable liquid that has been widely used in organic syntheses. For early examples, see Shioiri et al., J. Am. Chem. Soc. 1972, 94, 6203; Yamada et al., J. Am. Chem. Soc. 1975, 97, 7174. It was shown that the resulting phosphoryl nitrenes were so intriguingly nonselective that they underwent intermolecular C—H amination with the solvents without the normal preference for intramolecular reactions. See also, Breslow et al., J. Am. Chem. Soc. 1984, 106, 5359; Breslow et al., J. Am. Chem. Soc. 1984, 106, 5359; Maslak, J. Am. Chem. Soc. 1989, 111, 8201; and Maslak et al., Tetrahedron Lett. 1990, 31, 4261. While Rh₂Piv₄ was indicated to catalyze the intramolecular C—H amination, the catalytic thermolysis appeared to be ineffective (52% yield with 15% catalyst at 120° C. for 87 h). See, Breslow et al., J. Am. Chem. Soc. 1984, 106, 5359. For the use of DPPA in catalytic aziridination, see Gao et al., J. Org. Chem. 2006, 71, 6655; and Jones et al., J. Org. Chem. 2008, 73, 7260.

### SUMMARY OF THE INVENTION

Among the various aspects of the present invention, therefore, may be noted the provision of a catalytic process for intramolecular C—H amination with azides, more specifically, intramolecular C—H amination with phosphoryl azides to produce cyclophosphoramidates, and, in a preferred embodiment, a Co-based catalytic system for intramolecular C—H amination with benzophosphoryl azides, leading to the valuable benzoheterocyclo derivatives in excellent yields.

Briefly, therefore, the present invention is directed to a process for the preparation of a phosphoramidate, the process comprising treating a phosphorylazide with a metal porphyrin complex to catalyze the amination of a C—H bond to form a phosphoramidate having 6 or 7 ring atoms.

One aspect of the present invention is a process for the preparation of a phosphoramidate, the process comprising treating a phosphorylazide with a metal porphyrin complex to catalyze the amination of a C—H bond to form a phosphoramidate having 6 or 7 ring atoms wherein the phosphorylazide corresponds to Formula 1 and the phosphoramidate corresponds to Formula 2

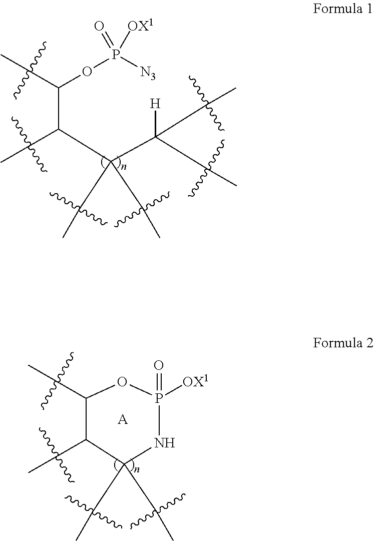

Other objects and features will be in part apparent and in part pointed out hereinafter.

### ABBREVIATIONS AND DEFINITIONS

The following definitions and methods are provided to better define the present invention and to guide those of ordinary skill in the art in the practice of the present invention. Unless otherwise noted, terms are to be understood according to conventional usage by those of ordinary skill in the relevant art.

The term “acyl,” as used herein alone or as part of another group, denotes the moiety formed by removal of the hydroxyl group from the group—COOH of an organic carboxylic acid, e.g., RC(O)—, wherein R is R1, R1O—, R1R2N— or R1S—, R1 is hydrocarbyl, heterosubstituted hydrocarbyl, or heterocyclo and R2 is hydrogen, hydrocarbyl or substituted hydrocarbyl.

The term “acyloxy,” as used herein alone or as part of another group, denotes an acyl group as described above bonded through an oxygen linkage (O), e.g., RC(O)O wherein R is as defined in connection with the term “acyl.”

Unless otherwise indicated, the alkenyl groups described herein are preferably lower alkenyl containing from two to eight carbon atoms in the principal chain and up to 20 carbon atoms. They may be straight or branched chain or cyclic and include ethenyl, propenyl, isopropenyl, butenyl, isobutenyl, hexenyl, and the like.

The terms “alkoxy” or “alkoxyl” as used herein alone or as part of another group denote any univalent radical, RO— where R is an alkyl group.

Unless otherwise indicated, the alkyl groups described herein are preferably lower alkyl containing from one to eight carbon atoms in the principal chain and up to 20 carbon atoms. They may be straight or branched chain or cyclic and include methyl, ethyl, propyl, isopropyl, butyl, hexyl, and the like. The substituted alkyl groups described herein may have, as substituents, any of the substituents identified as substituted hydrocarbyl substituents.

Unless otherwise indicated, the alkynyl groups described herein are preferably lower alkynyl containing from two to eight carbon atoms in the principal chain and up to 20 carbon atoms. They may be straight or branched chain and include ethynyl, propynyl, butynyl, isobutynyl, hexynyl, and the like.

The terms “aryl” or “ar” as used herein alone or as part of another group denote optionally substituted homocyclic aromatic groups, preferably monocyclic or bicyclic groups containing from 6 to 12 carbons in the ring portion, as phenyl, biphenyl, naphthyl, substituted phenyl, substituted biphenyl or substituted naphthyl. Phenyl and substituted phenyl are the more preferred aryl. The substituted aryl groups described herein may have, as substituents, any of the substituents identified as substituted hydrocarbyl substituents.

The terms “diazo” or “azo” as used herein'alone or as part of another group denote an organic compound with two linked nitrogen compounds. These moieties include without limitation diazomethane, ethyl diazoacetate, and t butyl diazoacetate.

The term “electron acceptor” as used herein denotes a chemical moiety that accepts electrons. Stated differently, an electron acceptor is a chemical moiety that accepts either a fractional electronic charge from an electron donor moiety to form a charge transfer complex, accepts one electron from an electron donor moiety in a reduction-oxidation reaction, or accepts a paired set of electrons from an electron donor moiety to form a covalent bond with the electron donor moiety.

The terms “halogen” or “halo” as used herein alone or as part of another group denote chlorine, bromine, fluorine, and iodine.

The term “heteroaromatic” as used herein alone or as part of another group denotes optionally substituted aromatic groups having at least one heteroatom in at least one ring, and preferably 5 or 6 atoms in each ring. The heteroaromatic group preferably has 1 or 2 oxygen atoms, 1 or 2 sulfur atoms, and/or 1 to 4 nitrogen atoms in the ring, and may be bonded to the remainder of the molecule through a carbon or heteroatom. Exemplary heteroaromatics include furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxyl, protected hydroxyl, acyl, acyloxy, alkoxy, alkenoxy, alkynoxy, aryloxy, halogen, amido, amino, nitro, cyano, thiol, ketals, acetals, esters and ethers.

The term “heteroatom” as used herein denotes atoms other than carbon and hydrogen.

The terms “heterocyclo” or “heterocyclic” as used herein alone or as part of another group denote optionally substituted, fully saturated or unsaturated, monocyclic or bicyclic, aromatic or nonaromatic groups having at least one heteroatom in at least one ring, and preferably 5 or 6 atoms in each ring. The heterocyclo group preferably has 1 or 2 oxygen atoms, 1 or 2 sulfur atoms, and/or 1 to 4 nitrogen atoms in the ring, and may be bonded to the remainded of the molecule through a carbon or heteroatom. Exemplary heterocyclo include heteroaromatics as furyl, thienyl, pyridyl, oxazolyl, pyrrolyl, indolyl, quinolinyl, or isoquinolinyl and the like. Exemplary substituents include one or more of the following groups: hydrocarbyl, substituted hydrocarbyl, keto, hydroxyl, protected hydroxyl, acyl, acyloxy, alkoxy, alkenoxy, alkynoxy, aryloxy, halogen, amido, amino, nitro, cyano, thiol, ketals, acetals, esters and ethers.

The terms “hydrocarbon” and “hydrocarbyl” as used herein alone or as part of another group denote organic compounds or radicals consisting exclusively of the elements carbon and hydrogen. These moieties include alkyl, alkenyl, alkynyl, and aryl moieties. These moieties also include alkyl, alkenyl, alkynyl, and aryl moieties substituted with other aliphatic or cyclic hydrocarbon groups, as alkaryl, alkenaryl, and alkynaryl. Unless otherwise indicated, these moieties preferably comprise 1 to 20 carbon atoms.

The term porphyrin refers to a compound comprising a fundamental skeleton of four pyrrole nuclei united through the α-positions by four methane groups to form the following macrocyclic structure:

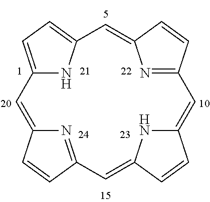

The “substituted hydrocarbyl” moieties described herein, e.g., the substituted alkyl, the substituted alkenyl, the substituted alkynyl, and the substituted aryl moieties, are hydrocarbyl moieties which are substituted with at least one atom other than carbon, including moieties in which a carbon chain atom is substituted with a hetero atom such as nitrogen, oxygen, silicon, phosphorous, boron, sulfur, or a halogen atom. These substitutents include halogen, heterocyclo, alkoxy, alkenoxy, alkynoxy, aryloxy, hydroxyl, protected hydroxy, keto, acyl, acyloxy, nitro, amino, amido, nitro, cyano, thiol, ketals, acetals, esters and ethers.

### DETAILED DESCRIPTION OF THE INVENTION

In accordance with the process of the present invention, intramolecular nitrene insertion of C—H bonds with phosphoryl azides may be catalyzed with metal porphyrin complexes. The catalytic system can be applied to primary, secondary, and tertiary C—H bonds and is suitable for a broad range of phosphoryl azides, e.g., arylphosphoryl azides. In addition, the metal porphyrin catalyzed process advantageously proceeds relatively efficiently under relatively mild and neutral conditions in low catalyst loading in a solvent such as trifluorotoluene.

We report herein that Co(II) complexes of appropriate porphyrins [Co(Por)] are highly effective catalysts for intramolecular C—H amination with phosphoryl azides under mild conditions. Determined by the nature of the azides, the Co(II)-based catalytic system can undergo 1,6- or 1,7-C—H nitrene insertion processes, forming O—P—N containing 6- or 7-membered benzoheterocyclic compounds in high yields (see Scheme A which shows Co(II)-catalyzed intramolecular 1,6- and 1,7-C—H nitrene insertion processes with phosphoryl azides in accordance with one embodiment of the present invention).

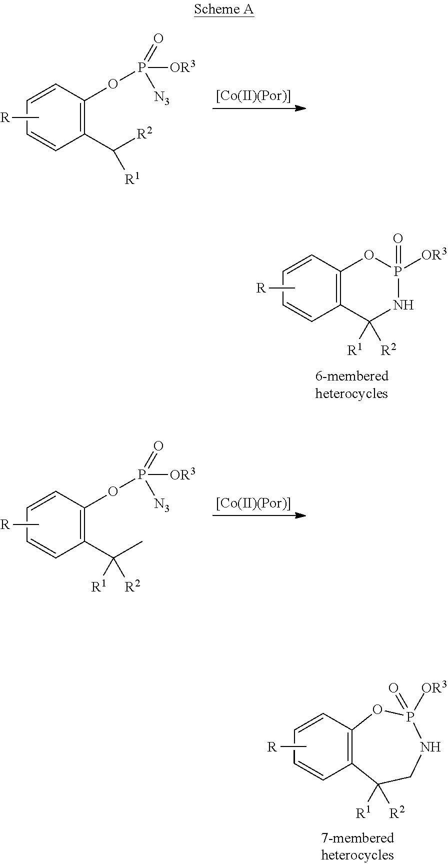

Cyclophosphoramidates and related heterocycles have found a number of applications, in particular in the fields of catalysis and medicine. See, for example, Denmark et al., Angew. Chem. Int. Ed. 2008, 47, 1560; Minnaard et al., Acc. Chem. Res. 2007, 40, 1267; Frank et al., J. Curr. Org. Chem. 2007, 11, 1610; Jiang et al., J. Med. Chem. 2006, 49, 4333; Kivela et al., J. Org. Chem. 2005, 1189; Caminade et al., Chem. Rev. 1994, 94, 1183; Brock, Cancer Res. 1989, 49, 1; Pankiewicz et al., J. Am. Chem. Soc. 1979, 101, 7712; Eto et al., Nature, 1963, 200, 171; and Arnold et al., Nature, 1958, 181, 931. For example, the 1,3,2-oxazaphosphinane ring system exists in anticancer drugs cyclophosphamide and ifosfamide

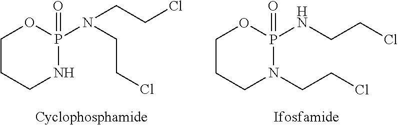

In addition to secondary and tertiary C—H bonds, the current catalytic system is featured with effective amination of both benzylic and non-benzylic primary C—H bonds.

In accordance with a preferred embodiment, a phosphoryl azide 1 is converted to a phosphoramidate 2 as illustrated in Reaction Scheme 1:

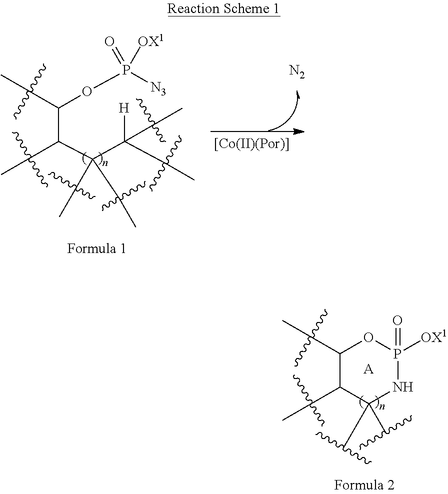

wherein Co(II)(Por) is an asymmetric cobalt(II) porphyrin complex, n is 0 or 1 and X¹ is hydrogen, hydrocarbyl, substituted hydrocarbyl, or heterocyclo. Thus, for example, when n is 0, phosphoramidate 2 is a 6-membered ring corresponding to Formula 3 and when n is 1, phosphoramidate 2 is a 6-membered ring corresponding to Formula 4:

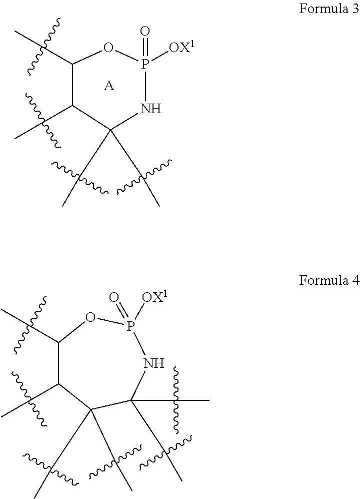

As depicted in Formulae 1, 2, 3, and 4, the metal porphyrin catalyzed intramolecular nitrene insertion of C—H bonds does not critically depend upon the substituents of the carbon atoms that are alpha, beta, gamma, or delta to the phosphorylazide moiety and, as such, only the bonds to other (unidentified) atoms are depicted.

In one preferred embodiment, phosphoramidate 2 is a 6-membered or 7-membered ring, A, corresponding to Formula 5 or Formula 6, respectively:

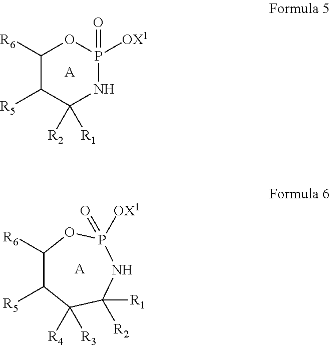

wherein R₁, R₂, R₃, and R₄ are independently hydrogen, hydrocarbyl, substituted hydrocarbyl, halo, hydroxy, alkoxy, or heterocyclo, R₅ and R₆ are independently hydrogen, hydrocarbyl, substituted hydrocarbyl, halo, hydroxy, alkoxy, amino or heterocyclo or, in combination form a carbocyclic or heterocyclic ring fused to the A ring of the phosphoramidate of Formula 5 or Formula 6, and X¹ is hydrogen, hydrocarbyl, substituted hydrocarbyl or heterocyclo. In one embodiment, R₁, R₂, R₃, and R₄ are independently hydrogen, hydrocarbyl, substituted hydrocarbyl or heterocyclo. For example, R₁, R₂, R₃, and R₄ may be independently selected from hydrogen, alkyl, alkenyl, aryl and heterocyclo. In one embodiment, one of R₁ and R₂ is hydrogen and the other is hydrocarbyl, substituted hydrocarbyl, halo, hydroxy, alkoxy, or heterocyclo; by way of example, in this embodiment, R₁ may be hydrogen and R₂ may be alkyl, aryl, or heterocyclo (such as furyl). Similarly, in one embodiment, one of R₃ and R₄ is hydrogen and the other is hydrocarbyl, substituted hydrocarbyl, halo, hydroxy, alkoxy, or heterocyclo; by way of example, in this embodiment, R₃ may be hydrogen and R₄ may be alkyl, aryl, or heterocyclo (such as furyl). In another embodiment, the ring carbon atom to which R₁ and R₂ are attached is a spiro atom and R₁, R₂, and the spiro carbon atom to which they are attached, in combination, form a ring, typically containing three to seven ring atoms selected from carbon, oxygen, nitrogen and sulfur; in this embodiment, R₃, and R₄, may, for example, be independently selected from hydrogen, alkyl, and halo. In another embodiment, the ring carbon atom to which R₃ and R₄ are attached is a spiro atom and R₃, R₄, and the spiro carbon atom to which they are attached, in combination, form a ring, typically containing three to seven ring atoms selected from carbon, oxygen, nitrogen and sulfur; in this embodiment, R₁ and R₂ may preferably be independently selected from hydrogen, alkyl, and halo In each of these embodiments, R₅ and R₆, in combination, may form a carbocyclic or heterocyclic ring fused to the A ring of the phosphoramidate of Formula 5 or Formula 6. For purposes of illustration, when R₅ and R₆, in combination, form a carbocyclic or heterocyclic ring, the phosphoramidate corresponds to Formula 7 or Formula 8:

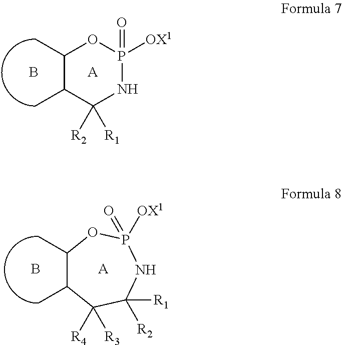

wherein the B ring is a carbocylic or heterocyclic ring, and R₁, R₂, R₃, R₄ and X¹ are as defined in connection with Formulae 5 and 6. In one preferred embodiment, the B ring is an optionally substituted 5-membered heterocyclic ring or an optionally substituted 6-membered carbocyclic or heterocylic ring. Exemplary 5-membered and 6-membered heterocycles include pyrrolidinyl, tetrahydrofuranyl, tetrahydrothienyl, tetrahydropyranyl, tetrahydrothiopyranyl, piperidino, morpholino, thiomorpholino, thioxanyl, piperazinyl, homopiperidinyl, 1,2,3,6-tetrahydropyridinyl, 2-pyrrolinyl, 3-pyrrolinyl, 2H-pyranyl, 4H-pyranyl, dioxanyl, 1,3-dioxolanyl, pyrazolinyl, dithianyl, dithiolanyl, dihydropyranyl, dihydrothienyl, dihydrofuranyl, pyrazolidinyl, imidazolinyl, imidazolidinyl. Examplary 5-membered and 6-membered aromatic heterocyclic groups include imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, pyridyl, pyridazinyl, triazinyl, oxadiazolyl, thiadiazolyl, and furazanyl. By way of further example, the B ring may be an optionally substituted, fused cyclohexyl or phenyl ring with the substituent(s) being selected from lower alkyl, hydroxy, alkoxy, amino, halo, nitro and heterocylco. In another embodiment, the B ring may be an optionally substituted, fused pyridyl, pyrimidinyl, pyradizinyl, pyrizinyl, furyl, thienyl, isoxazolyl, or pyrrolyl; thus, for example, the B ring may be an optionally substituted, fused pyridyl, furyl, thienyl, or pyrrolyl ring with the substituent(s) being selected from lower alkyl, hydroxy, alkoxy, amino, halo, and nitro.

In another preferred embodiment, phosphoramidate 2 is a benzophosphoramidate corresponding to Formula 9 or Formula 10:

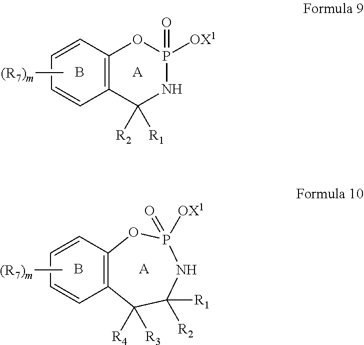

wherein R₁, R₂, R₃, and R₄ are independently hydrogen, hydrocarbyl, substituted hydrocarbyl, halo, hydroxy, alkoxy, amino, nitro, or heterocyclo, each R₇ is independently hydrocarbyl, substituted hydrocarbyl, halo, amino, nitro, alkoxy, hydroxy, acyl, acyloxy, or heterocyclo, m is 0 to 4, and X¹ is hydrogen, hydrocarbyl, substituted hydrocarbyl or heterocyclo. Thus, for example, when phosphoramidate 2 corresponds to Formula 9 or Formula 10, m may be 1 to 4 and each R₇ may independently be alkyl, halo, amino, nitro, alkoxy, hydroxy, acyl or acyloxy. By way of further example, when phosphoramidate 2 corresponds to Formula 9 or Formula 10, m may be 1 to 4 and each R₇ may independently be alkyl, halo, alkoxy, hydroxy, or nitro. By way of further example, when phosphoramidate 2 corresponds to Formula 9 or Formula 10, m may be 1 to 4 and each R₇ may independently be alkyl, substituted alkyl, halo or nitro. By way of further example, when phosphoramidate 2 corresponds to Formula 9 or Formula 10, m may be 1 to 4 and each R₇ may be alkyl. In one embodiment in which phosphoramidate 2 is a benzophosphoramidate corresponding to Formula 9 or Formula 10, one of R₁ and R₂ is hydrogen and the other is hydrocarbyl, substituted hydrocarbyl, halo, hydroxy, alkoxy, or heterocyclo; by way of example, in this embodiment, R₁ may be hydrogen and R₂ may be alkyl, aryl, or heterocyclo (such as furyl). Similarly, in one such embodiment, one of R₃ and R₄ is hydrogen and the other is hydrocarbyl, substituted hydrocarbyl, halo, hydroxy, alkoxy, or heterocyclo; by way of example, in this embodiment, R₃ may be hydrogen and R₄ may be alkyl, aryl, or heterocyclo (such as furyl).

In one exemplary embodiment, Co(II) porphyrin complexes such as [Co(P1)], [Co(P2)], [Co(P3)] and [Co(P4)] are used as a catalyst for intramolecular nitrene insertion of C—H bonds in arylphosphorylazides, 11, leading to the high-yielding syntheses of corresponding benzophosphoramidate derivatives, 12, proceeding efficiently under mild and neutral conditions in low catalyst loading without the need of other reagents or additives, generating dinitrogen as the byproduct as illustrated in Reaction Scheme 2

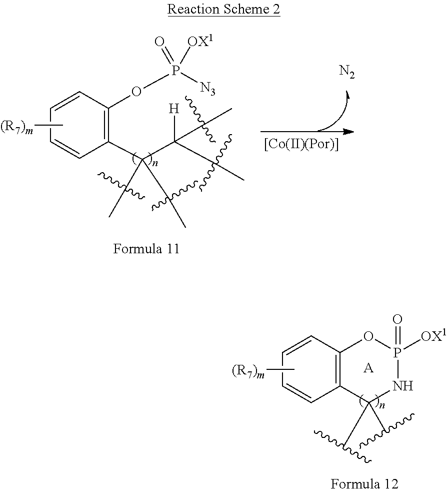

wherein m, n, R₇, and X¹ are as defined in connection with Formulae 9 and 10. In one such embodiment, m is at least 1, and each R₇ is independently hydrogen, hydrocarbyl, substituted hydrocarbyl, halo, amino, nitro, alkoxy, hydroxy, acyl, acyloxy or heterocyclo.

In another exemplary embodiment, Co(II) porphyrin complexes such as [Co(P1)], [Co(P2)], [Co(P3)] and [Co(P4)] are used as a catalyst for intramolecular nitrene insertion of C—H bonds in arylphosphorylazides, 9A, leading to the high-yielding syntheses of corresponding benzophosphoramidate derivatives, 9, proceeding efficiently under mild and neutral conditions in low catalyst loading without the need of other reagents or additives, generating dinitrogen as the byproduct as illustrated in Reaction Scheme 3

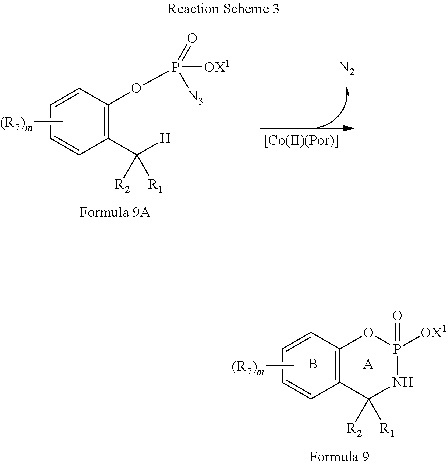

wherein m, n R₇, and X¹ are as previously defined in connection with Formula 9. In one such embodiment, m is at least 1 and each R₇ is independently hydrogen, hydrocarbyl, substituted hydrocarbyl, halo, amino, nitro, alkoxy, hydroxy, acyl, acyloxy or heterocyclo. In one embodiment, R₁ and R₂ are independently hydrogen, alkyl, halo or nitro and each R₇ is independently hydrocarbyl, substituted hydrocarbyl, halo, amino, nitro, alkoxy, hydroxy, acyl, acyloxy, or heterocyclo. In another embodiment, R₁ and R₂ are independently hydrogen, alkyl, or hydroxy and each R₇ is independently hydrocarbyl, substituted hydrocarbyl, halo, amino, nitro, alkoxy, hydroxy, acyl, acyloxy, or heterocyclo. In another embodiment, R₁ and R₂ are independently hydrogen, alkyl, or amino and each R₇ is independently hydrocarbyl, substituted hydrocarbyl, halo, amino, nitro, alkoxy, hydroxy, acyl, acyloxy, or heterocyclo. In another embodiment, the ring carbon atom to which R₁ and R₂ are attached is a spiro atom and R₁, R₂, and the spiro carbon atom to which they are attached, in combination, form a ring, typically containing three to seven ring atoms selected from carbon, oxygen, nitrogen and sulfur; in this embodiment, each R₇ is independently hydrocarbyl, substituted hydrocarbyl, halo, amino, nitro, alkoxy, hydroxy, acyl, acyloxy, or heterocyclo.

In yet another exemplary embodiment, Co(II) porphyrin complexes, for example, [Co(P1)], [Co(P2)], [Co(P3)] and [Co(P4)] have been shown to be an effective catalyst for intramolecular nitrene insertion of C—H bonds with a broad range of arylphosphorylazides, 10A, leading to the high-yielding syntheses of corresponding benzophosphoramidate derivatives, 10, proceeding efficiently under mild and neutral conditions in low catalyst loading without the need of other reagents or additives, generating dinitrogen as the byproduct as illustrated in Reaction Scheme 4

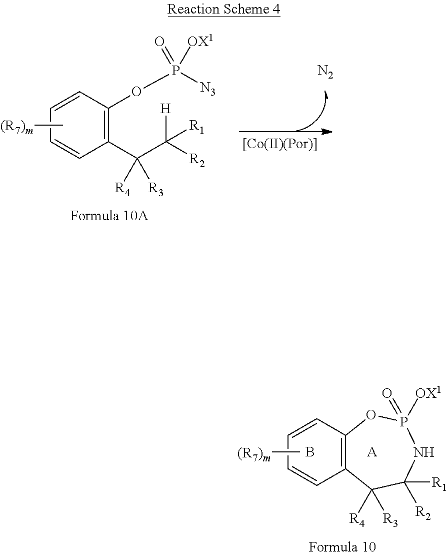

wherein m, n R₇, and X¹ are as previously defined in connection with Formula 10. In one such embodiment, m is at least 1 and each R₇ is independently hydrogen, hydrocarbyl, substituted hydrocarbyl, halo, amino, nitro, alkoxy, hydroxy, acyl, acyloxy or heterocyclo. In one embodiment, R₁ and R₂ are independently hydrogen, alkyl, halo or nitro and each R₇ is independently hydrocarbyl, substituted hydrocarbyl, halo, amino, nitro, alkoxy, hydroxy, acyl, acyloxy, or heterocyclo. In another embodiment, R₁ and R₂ are independently hydrogen, alkyl, or hydroxy and each R₇ is independently hydrocarbyl, substituted hydrocarbyl, halo, amino, nitro, alkoxy, hydroxy, acyl, acyloxy, or heterocyclo. In another embodiment, R₁ and R₂ are independently hydrogen, alkyl, or amino and each R₇ is independently hydrocarbyl, substituted hydrocarbyl, halo, amino, nitro, alkoxy, hydroxy, acyl, acyloxy, or heterocyclo. In another embodiment, the ring carbon atom to which R₁ and R₂ are attached is a spiro atom and R₁, R₂, and the spiro carbon atom to which they are attached, in combination, form a ring, typically containing three to seven ring atoms selected from carbon, oxygen, nitrogen and sulfur; in this embodiment, each R₇ is independently hydrocarbyl, substituted hydrocarbyl, halo, amino, nitro, alkoxy, hydroxy, acyl, acyloxy, or heterocyclo. In another embodiment, the ring carbon atom to which R₃ and R₄ are attached is a spiro atom and R₃, R₄, and the spiro carbon atom to which they are attached, in combination, form a ring, typically containing three to seven ring atoms selected from carbon, oxygen, nitrogen and sulfur; in this embodiment, R₁ and R₂ may preferably be independently selected from hydrogen, alkyl, and halo, and each R₇ is independently hydrocarbyl, substituted hydrocarbyl, halo, amino, nitro, alkoxy, hydroxy, acyl, acyloxy, or heterocyclo.

Metal Porphyrins

The porphyrin with which the transition metal is complexed may be any of a wide range of porphyrins known in the art. Exemplary porphyrins are described in U.S. Patent Publication Nos. 2005/0124596 and 2006/0030718 and U.S. Pat. No. 6,951,935 (each of which is incorporated herein by reference, in its entirety). Exemplary porphyrins are also described in Chen et al., Bromoporphyrins as Versatile Synthons for Modular Construction of Chiral Porphyrins: Cobalt-Catalyzed Highly Enantioselective and Diastereoselective Cyclopropanation (J. Am. Chem. Soc. 2004), which is incorporated herein by reference in its entirety.

In one embodiment, the metal porphyrin complex is a cobalt(II) porphyrin complex. In one particularly preferred embodiment, the cobalt porphyrin complex is a chiral porphyrin complex corresponding to the following structure

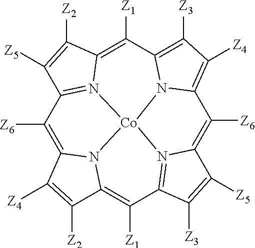

wherein each Z₁, Z₂, Z₃, Z₄, Z₅ and Z₆ are each independently selected from the group consisting of X, H, alkyl, substituted alkyls, arylalkyls, aryls and substituted aryls; and X is selected from the group consisting of halogen, trifluoromethanesulfonate (OTf), haloaryl and haloalkyl. In a preferred embodiment, Z₂, Z₃, Z₄ and Z₅ are hydrogen, Z₁ is a substituted phenyl, Z₆ is substituted phenyl, and Z₁ and Z₆ are different. In one particularly preferred embodiment, Z₂, Z₃, Z₄ and Z₅ are hydrogen, Z₁ is substituted phenyl, Z₆ is substituted phenyl, Z₁ and Z₆ are different, and the porphyrin is a chiral porphyrin. In one even further preferred embodiment, Z₂, Z₃, Z₄ and Z₅ are hydrogen, Z₁ is substituted phenyl, Z₆ is substituted phenyl, Z₁ and Z₆ are different and the porphyrin has D₂-symmetry.

In one embodiment, the cobalt porphyrin complex is a chiral Co(II) porphyrin complex having D₂-symmetry and corresponding to the structure

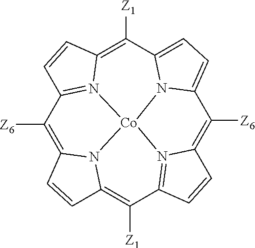

wherein Z₁ is optionally substituted phenyl,

Z₆ is

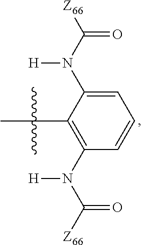

Z₆₆ is hydrocarbyl, substituted hydrocarbyl, or heterocyclo and

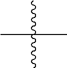

denotes the point of attachment to the porphyrin complex.

For example, in one such embodiment, the cobalt porphyrin complex is a chiral Co(II) porphyrin complex having D₂-symmetry and corresponding to the structure

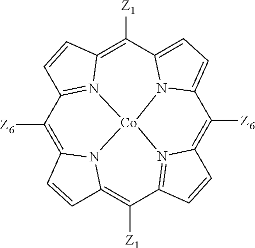

wherein Z₁ is optionally substituted phenyl,

Z₆ is

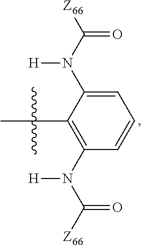

Z₆₆ is alkyl, substituted alkyl, or heterocyclo and

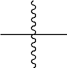

denotes the point of attachment to the porphyrin complex.

By way of further example, in one such embodiment, the cobalt porphyrin complex is a chiral Co(II) porphyrin complex having D₂-symmetry and corresponding to the structure

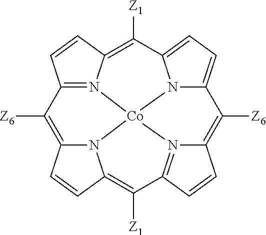

wherein Z₁ is phenyl, optionally alkyl or alkoxy substituted,

Z₆ is

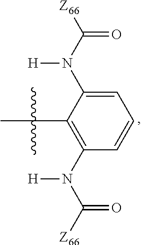

Z₆₆ is lower alkyl and

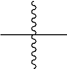

denotes the point of attachment to the porphyrin complex.

By way of further example, in one such embodiment, the cobalt porphyrin complex is a chiral Co(II) porphyrin complex having D₂-symmetry and corresponding to the structure

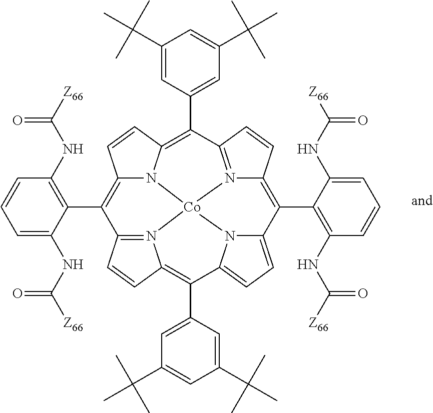

Z₆₆ is methyl, ethyl, isopropyl, or t-butyl.

By way of further example, in one embodiment, the cobalt porphyrin complex is a chiral Co(II) porphyrin complex having D₂-symmetry and corresponding to the structure

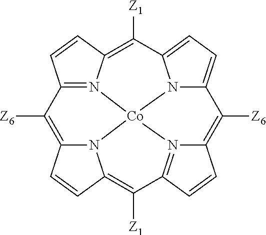

wherein

Z₁ is

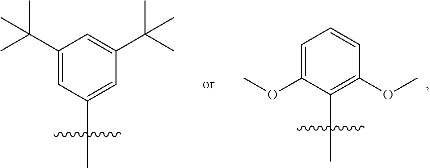

Z₆ is

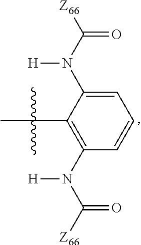

Z₆₆ is alkyl, substituted alkyl, or heterocyclo and

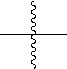

denotes the point of attachment to the porphyrin complex.

By way of further example, in one embodiment, the cobalt porphyrin complex is a chiral Co(II) porphyrin complex having D₂-symmetry and corresponding to the structure

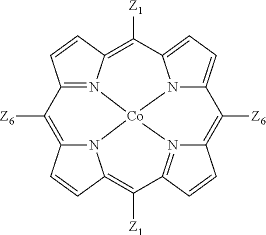

wherein Z₁ is selected from the group consisting of

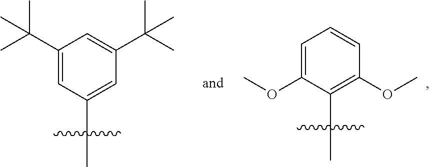

Z₆ is selected from the group consisting of

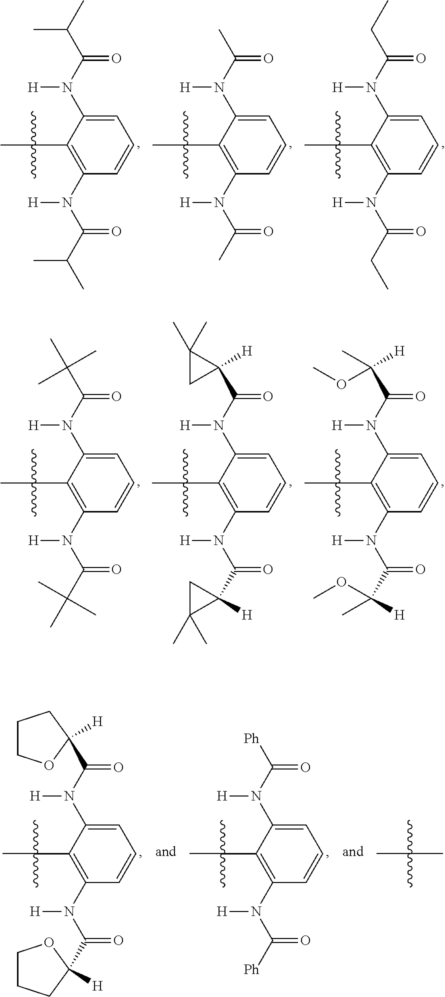

denotes the point of attachment to the porphyrin complex.

Exemplary cobalt(II) porphyrins include the following, designated [Co(P1)], [Co(P2)], [Co(P3)], [Co(P4)] and [Co(P5)].

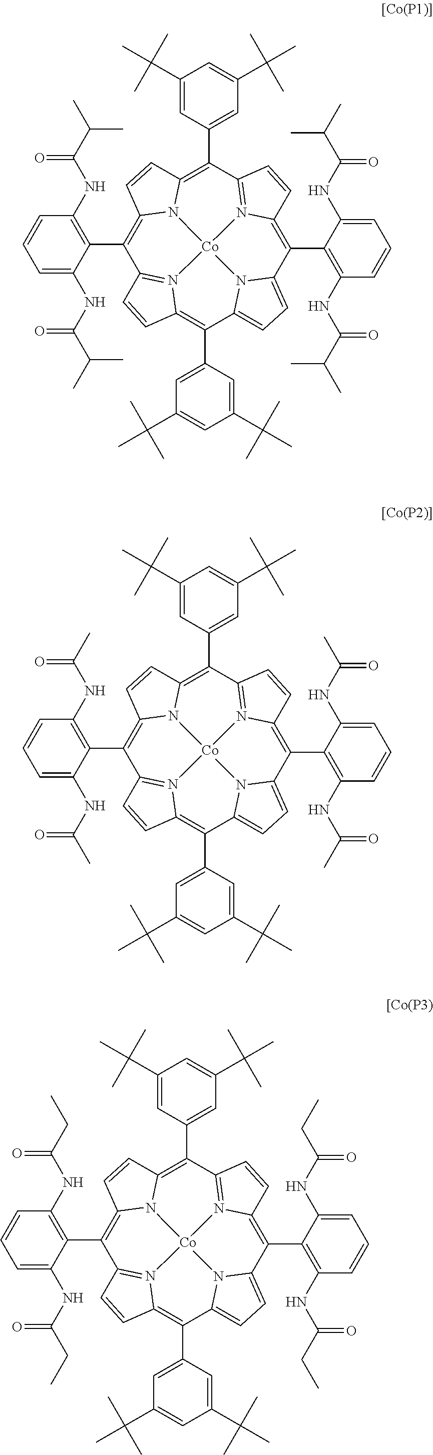

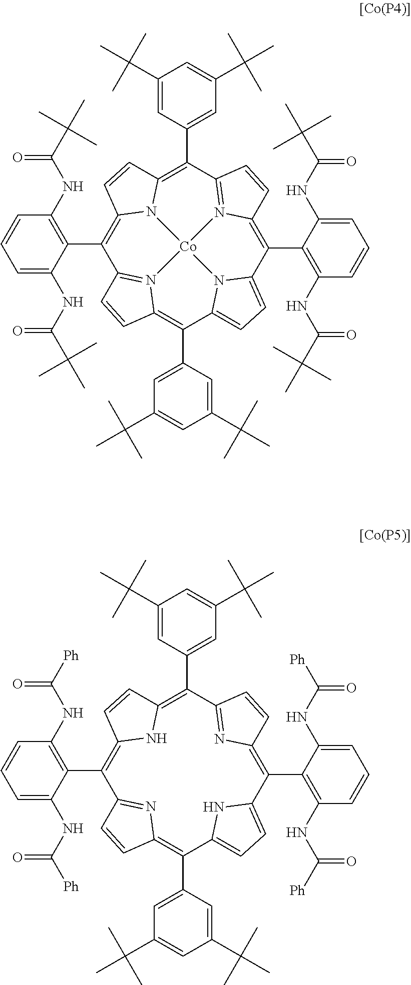

Other exemplary cobalt(II) porphyrins include the following, designated [Co(P11)], [Co(P12)], [Co(P13)], [Co(P14)], [Co(P15)], and [Co(P16)],

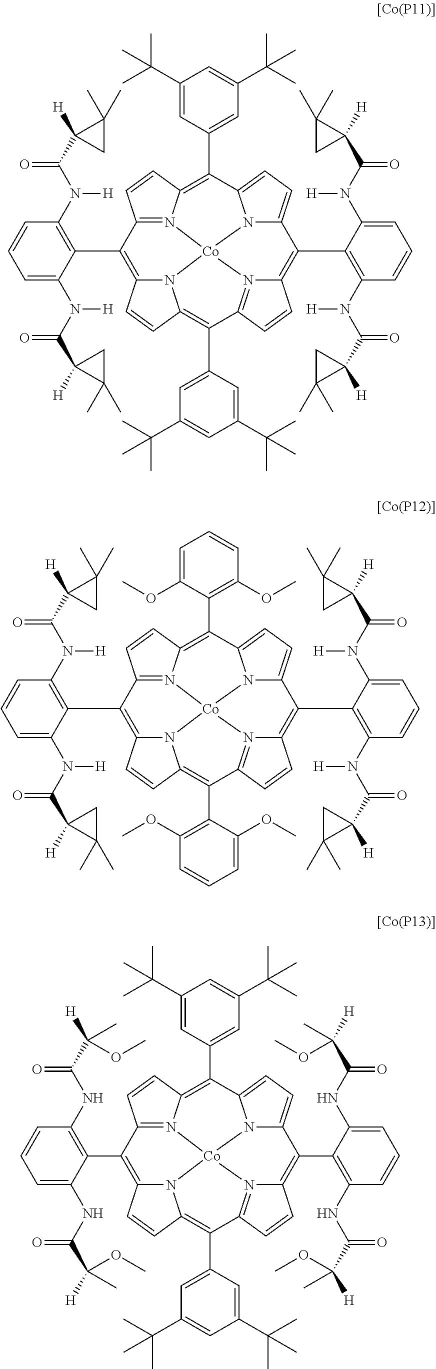

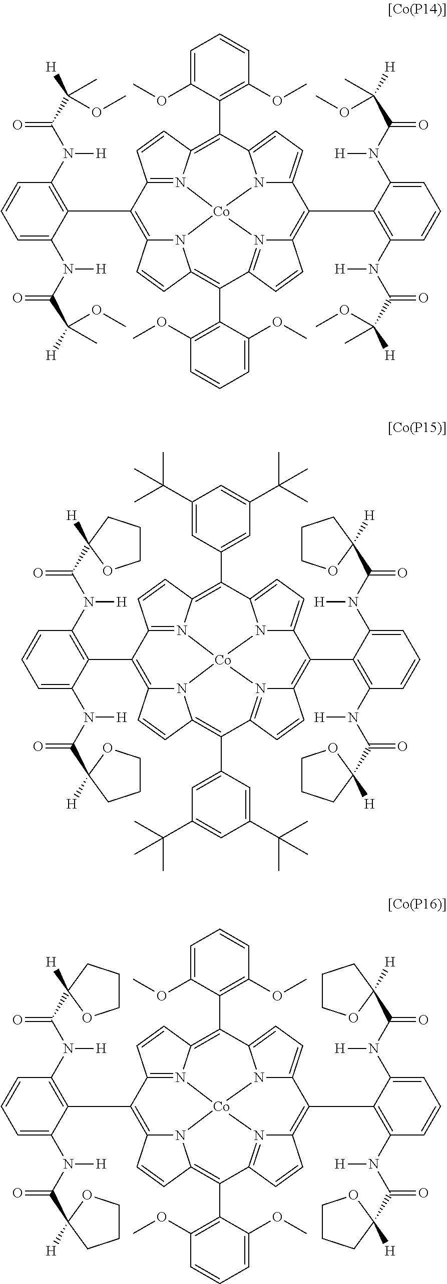

Amino Alcohols

In addition to the various uses of cyclophosphoramidates shown in the literature (see, for example, Denmark, S. E.; Beutner, G. L. Angew. Chem. Int. Ed. 2008, 47, 1560. (b) Minnaard, A. J.; Feringa, B. L.; Lefort, L.; de Vries, J. G. Acc. Chem. Res. 2007, 40, 1267. (c) Frank, E.; Wolfling, J. Curr. Org. Chem. 2007, 11, 1610. (d) Jiang, Y.; Han, J.; Yu, C.; Vass, S. O.; Searle, P. F.; Browne, P.; Knox, R. J.; Hu, L. J. Med. Chem. 2006, 49, 4333. (e) Kivela, H.; Zalan, Z.; Tahtinen, P.; Sillanpaa, R; Fulop, F.; Phihlaja, K. Eur. J. Org. Chem. 2005, 1189. (f) Caminade, A.-M.; Majorai, J. P. Chem. Rev. 1994, 94, 1183. (g) Brock, N. Cancer Res. 1989, 49, 1. (h) Pankiewicz, K.; Kinas, R.; Stec, W. J.; Foster, A. B.; Jarman, M.; Van Maanen, M. S. J. Am. Chem. Soc. 1979, 101, 7712. (i) Eto, M.; Kinoshita, Y.; Kato, T.; Oshima, Y. Nature, 1963, 200, 171. (j) Arnold, H.; Bourseaux, F.; Brock, N. Nature, 1958, 181, 931), the cyclophosphoramidates of the present invention may also be used for the preparation of synthetically valuable 1,3-amino alcohols and 1,4-amino alcohols. For example, cyclophosphoramidate 2 may be treated with a base to open the ring as shown in Reaction Scheme 5. Treatment of cyclophosphoramidate 2 with a strong base, such as lithium aluminum hydride in tetrahydrofuran opens and dephosphorylates the substrate to yield a fully deprotected product, Formula 11. Alternatively, treatment of cyclophosphoramidate 2 with a weaker base, such as ammonia in methanol opens, but does not phosphorylate the substrate to yield partially deprotected product, Formula 12.

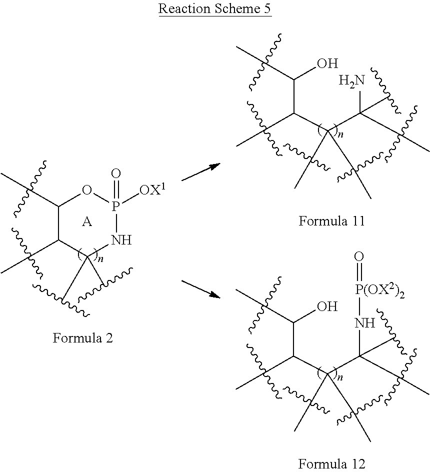

wherein n is 0 or 1 and each X² is independently hydrogen, hydrocarbyl or substituted hydrocarbyl.

In one embodiment, cyclophosphoramidate 5 is treated with a base to open the ring as shown in Reaction Scheme 6. Treatment of cyclophosphoramidate 5 with a strong base, such as lithium aluminum hydride in tetrahydrofuran opens and dephosphorylates the substrate to yield a fully deprotected product, 11A. Alternatively, treatment of cyclophosphoramidate 5 with a weaker base, such as ammonia in methanol opens, but does not phosphorylate the substrate to yield partially deprotected product 12A.

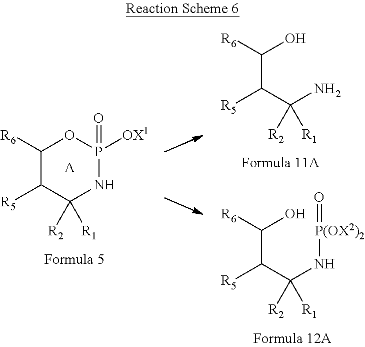

wherein R₁ and R₂ are independently hydrogen, hydrocarbyl, substituted hydrocarbyl, halo, hydroxy, alkoxy, or heterocyclo, R₅ and R₆ are independently hydrogen, hydrocarbyl, substituted hydrocarbyl, halo, hydroxy, alkoxy, amino or heterocyclo or, in combination form a carbocyclic or heterocyclic ring fused to the A ring of the phosphoramidate of Formula 5, X¹ is hydrogen, hydrocarbyl, substituted hydrocarbyl or heterocyclo, and each X² is independently hydrogen, hydrocarbyl or substituted hydrocarbyl. In one embodiment, R₁ and R₂ are independently hydrogen, hydrocarbyl, substituted hydrocarbyl or heterocyclo. For example, R₁ and R₂ may be independently selected from hydrogen, alkyl, alkenyl, aryl and heterocyclo. In one embodiment, one of R₁ and R₂ is hydrogen and the other is hydrocarbyl, substituted hydrocarbyl, halo, hydroxy, alkoxy, or heterocyclo; by way of example, in this embodiment, R₁ may be hydrogen and R₂ may be alkyl, aryl, or heterocyclo (such as furyl). In another embodiment, the ring carbon atom to which R₁ and R₂ are attached is a spiro atom and R₁, R₂, and the spiro carbon atom to which they are attached, in combination, form a ring, typically containing three to seven ring atoms selected from carbon, oxygen, nitrogen and sulfur. In each of these embodiments, R₅ and R₆, in combination, may form a carbocyclic or heterocyclic ring fused to the A ring of the phosphoramidate of Formula 5.

In one embodiment, the cyclophosphoramidate is a seven-membered heterocylco, cyclophosphoramidate 6 as depicted in Reaction Scheme 7. Treatment of cyclophosphoramidate 6 with a strong base, such as lithium aluminum hydride in tetrahydrofuran opens and dephosphorylates the cyclophosphoramidate substrate to yield a fully deprotected product, 11B. Alternatively, treatment of cyclophosphoramidate 6 with a weaker base, such as ammonia in methanol opens, but does not phosphorylate the substrate to yield partially deprotected product, Formula 12B.

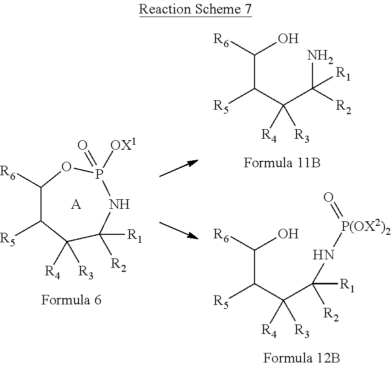

wherein R₁, R₂, R₃, and R₄ are independently hydrogen, hydrocarbyl, substituted hydrocarbyl, halo, hydroxy, alkoxy, or heterocyclo, R₅ and R₆ are independently hydrogen, hydrocarbyl, substituted hydrocarbyl, halo, hydroxy, alkoxy, amino or heterocyclo or, in combination form a carbocyclic or heterocyclic ring fused to the A ring of the phosphoramidate of Formula 6, X¹ is hydrogen, hydrocarbyl, substituted hydrocarbyl or heterocyclo, and each X² is independently hydrogen, hydrocarbyl or substituted hydrocarbyl. In one embodiment, R₁, R₂, R₃, and R₄ are independently hydrogen, hydrocarbyl, substituted hydrocarbyl or heterocyclo. For example, R₁, R₂, R₃, and R₄ may be independently selected from hydrogen, alkyl, alkenyl, aryl and heterocyclo. In one embodiment, one of R₁ and R₂ is hydrogen and the other is hydrocarbyl, substituted hydrocarbyl, halo, hydroxy, alkoxy, or heterocyclo; by way of example, in this embodiment, R₁ may be hydrogen and R₂ may be alkyl, aryl, or heterocyclo (such as furyl). Similarly, in one embodiment, one of R₃ and R₄ is hydrogen and the other is hydrocarbyl, substituted hydrocarbyl, halo, hydroxy, alkoxy, or heterocyclo; by way of example, in this embodiment, R₃ may be hydrogen and R₄ may be alkyl, aryl, or heterocyclo (such as furyl). In another embodiment, the ring carbon atom to which R₁ and R₂ are attached is a spiro atom and R₁, R₂, and the spiro carbon atom to which they are attached, in combination, form a ring, typically containing three to seven ring atoms selected from carbon, oxygen, nitrogen and sulfur; in this embodiment, R₃, and R₄, may, for example, be independently selected from hydrogen, alkyl, and halo. In another embodiment, the ring carbon atom to which R₃ and R₄ are attached is a spiro atom and R₃, R₄, and the spiro carbon atom to which they are attached, in combination, form a ring, typically containing three to seven ring atoms selected from carbon, oxygen, nitrogen and sulfur; in this embodiment, R₁ and R₂ may preferably be independently selected from hydrogen, alkyl, and halo In each of these embodiments, R₅ and R₆, in combination, may form a carbocyclic or heterocyclic ring fused to the A ring of the phosphoramidate of Formula 6.

For purposes of illustration, when R₅ and R₆, in combination, form a carbocyclic or heterocyclic ring, the amino alcohol produced by the treatment of phosphorphamidate 5 (Reaction Scheme 6) with base corresponds to Formula 11C or Formula 12C:

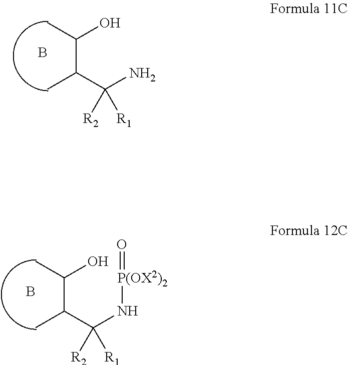

and the amino alcohol produced by the treatment of phosphorphamidate 6 (Reaction Scheme 7) with base corresponds to Formula 11D or Formula 12D:

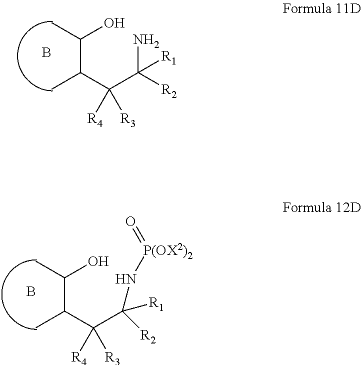

wherein the B ring is a carbocylic or heterocyclic ring, R₁, R₂, R₃, R₄ and X¹ are as defined in connection with Formulae 5 and 6, and each X² is independently hydrogen, hydrocarbyl or substituted hydrocarbyl. In one preferred embodiment, the B ring is an optionally substituted 5-membered heterocyclic ring or an optionally substituted 6-membered carbocyclic or heterocylic ring. Exemplary 5-membered and 6-membered heterocycles include pyrrolidinyl, tetrahydrofuranyl, tetrahydrothienyl, tetrahydropyranyl, tetrahydrothiopyranyl, piperidino, morpholino, thiomorpholino, thioxanyl, piperazinyl, homopiperidinyl, 1,2,3,6-tetrahydropyridinyl, 2-pyrrolinyl, 3-pyrrolinyl, 2H-pyranyl, 4H-pyranyl, dioxanyl, 1,3-dioxolanyl, pyrazolinyl, dithianyl, dithiolanyl, dihydropyranyl, dihydrothienyl, dihydrofuranyl, pyrazolidinyl, imidazolinyl, imidazolidinyl. Examplary 5-membered and 6-membered aromatic heterocyclic groups include imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, pyridyl, pyridazinyl, triazinyl, oxadiazolyl, thiadiazolyl, and furazanyl. By way of further example, the B ring may be an optionally substituted, fused cyclohexyl or phenyl ring with the substituent(s) being selected from lower alkyl, hydroxy, alkoxy, amino, halo, nitro and heterocylco. In another embodiment, the B ring may be an optionally substituted, fused pyridyl, pyrimidinyl, pyradizinyl, pyrizinyl, furyl, thienyl, isoxazolyl, or pyrrolyl; thus, for example, the B ring may be an optionally substituted, fused pyridyl, furyl, thienyl, or pyrrolyl ring with the substituent(s) being selected from lower alkyl, hydroxy, alkoxy, amino, halo, and nitro.

In one embodiment, when R₅ and R₆, in combination, form a phenyl ring, the amino alcohol produced by the treatment of phosphorphamidate 5 (Reaction Scheme 6) with base corresponds to Formula 11E or Formula 12E:

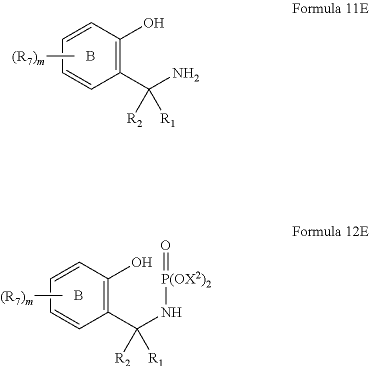

and the amino alcohol produced by the treatment of phosphorphamidate 6 (Reaction Scheme 7) with base corresponds to Formula 11F or Formula 12F:

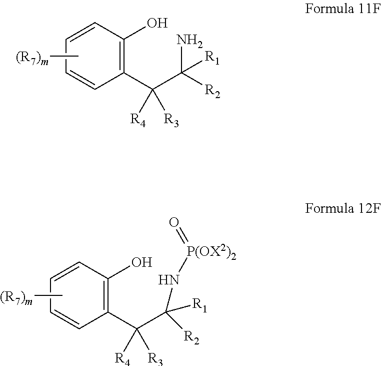

wherein R₁, R₂, R₃, and R₄ are independently hydrogen, hydrocarbyl, substituted hydrocarbyl, halo, hydroxy, alkoxy, amino, nitro, or heterocyclo, each R₇ is independently hydrocarbyl, substituted hydrocarbyl, halo, amino, nitro, alkoxy, hydroxy, acyl, acyloxy, or heterocyclo, m is 0 to 4, X¹ is hydrogen, hydrocarbyl, substituted hydrocarbyl or heterocyclo, and each X² is independently hydrogen, hydrocarbyl or substituted hydrocarbyl. Thus, for example, when the amino alcohol corresponds to Formula 11E, 11F, 12E, or 12F, m may be 1 to 4 and each R₇ may independently be alkyl, halo, amino, nitro, alkoxy, hydroxy, acyl or acyloxy. By way of further example, when amino alcohol corresponds to 11E, 11F, 12E, or 12F, m may be 1 to 4 and each R₇ may independently be alkyl, halo, alkoxy, hydroxy, or nitro. By way of further example, when amino alcohol corresponds to 11E, 11F, 12E, or 12F, m may be 1 to 4 and each R₇ may independently be alkyl, substituted alkyl, halo or nitro. By way of further example, when amino alcohol corresponds to 11E, 11F, 12E, or 12F, m may be 1 to 4 and each R₇ may be alkyl. In one embodiment in which amino alcohol corresponds to 11E, 11F, 12E, or 12F, one of R₁ and R₂ is hydrogen and the other is hydrocarbyl, substituted hydrocarbyl, halo, hydroxy, alkoxy, or heterocyclo; by way of example, in this embodiment, R₁ may be hydrogen and R₂ may be alkyl, aryl, or heterocyclo (such as furyl). Similarly, in one such embodiment, one of R₃ and R₄ is hydrogen and the other is hydrocarbyl, substituted hydrocarbyl, halo, hydroxy, alkoxy, or heterocyclo; by way of example, in this embodiment, R₃ may be hydrogen and R₄ may be alkyl, aryl, or heterocyclo (such as furyl).

The following examples illustrate the invention.

### Example 1

Using phosphoryl azide 1a as a model substrate, we performed a systematic investigation of its potential catalytic intramolecular C—H amination reactivity utilizing Co(II) complexes of different porphyrins under various conditions (Table 1 and Table S1). As summarized in Table 1, the commercially available [Co(TPP)] (TPP: tetraphenylporphyrin), which was demonstrated previously to be effective in catalyzing both intermolecular C—H amination of carbonyl azides (see Lu et al., Organometallics ASAP Dec. 22, 2009 (DOI: 10.1021/om900916g)) and intramolecular C—H amination of arylsulfonyl azides (see Ruppel et al., Org. Lett. 2007, 9, 4889) was unproductive for the amination of 1a (Table 1, entry 1), indicating phosphoryl azides have lower reactivity than carbonyl and sulfonyl azides. Encouraged by the hydrogen-bonding-enhanced catalysis observed in the previous aziridination system (see Ruppel et al., Org. Lett. 2008, 10, 1995. and Subbarayan et al., Chem. Comm. 2009, 4266), [Co(P1)], in which the D₂ₕ-symmetric porphyrin P1 has amide functionalities at the ortho-positions of the meso-phenyl groups, was employed as a potential catalyst and was indeed found to successfully catalyze formation of the desired amination product 2a in 79% yield (Table 1, entry 2). This suggests possible hydrogen-bonding interaction between the P═O and N—H units in the supposed nitrene intermediate. Consistent with this depiction, the use of [Co(P2)] and [Co(P3)], which have less steric amide functionalities, increased the yields of 2a to 98% and 96%, respectively (Table 1, entries 3 and 4). Conversely, 2a was only produced in a trace amount or not formed at all when [Co(P4)] or [Co(P5)] was used (Table 1, entries 5 and 6), presumably due to the weakening or prohibition of the hydrogen-bonding interaction resulting from the steric hindrance of the bulky amides.

Under an optimized condition (1-2 mol % of [Co(P2)] at 80° C. in PhCF₃ for 24 h), the Co(II)-based catalytic system was found to be effective for the intramolecular C—H amination with a range of phosphoryl azides (Table 2). DSC experiments indicated that these phosphoryl azides were stable without decomposition up to at least 250° C. (see Example 2 for details). For example, the primary C—H bonds of both azides 1a and 1b could be intramolecularly aminated, producing the 6-membered cyclophosphoramides 2a and 2b, respectively, in excellent yields (Table 2; entries 1 and 3). With a slightly higher catalyst loading (2 mol ° A)), it was noted that the reactions could be catalyzed in equally high yields by [Co(P1)] (Table 2; entries 2 and 4). As anticipated, tertiary and secondary C—H bonds of various types were also suitable substrates for the catalytic system, forming the desired 6-membered heterocycles as a mixture of trans- and cis-isomers (Table 2; entries 5-9). The selective formation of 2e from 1e without amination of the primary C—H bonds and aziridination of the C═C double bond (Table 2; entry 7) indicates that the catalytic system may allow for high control of chemoselectivity. When azide 1 h was used as the substrate, it was a surprise to observe the formation of 7-membered 2hb in addition to the major 6-membered 2ha (Table 2; entries 10-11), suggesting the unusual capability of the current catalytic system for the amination of both benzylic and non-benzylic primary C—H bonds as well as for the construction of medium-sized ring structures. It was shown subsequently that various 7-membered cyclophosphoramidates could be cleanly generated in high yields in the absence of benzylic C—H bonds as exemplified with azides 1i-1p that contains different functional groups (Table 2; entries 12-22).

Besides various spectroscopic characterizations, both the 6-membered (2a) and 7-membered (2n) O—P—N containing benzoheterocyclic structures were further confirmed by X-ray crystallographic analysis.

In addition to their various applications shown in literature, these cyclophosphoramidates should also serve as useful precursors for preparation of synthetically valuable 1,3- and 1,4-amino alcohols. As an example to demonstrate this kind of synthetic utility, the phosphoryl group of 7-membered amination product 2n could be fully deprotected upon treatment with LiAlH₄ in THF at room temperature, generating 1,4-amino alcohol 3n in 72% isolated yield (Scheme B). By changing reaction conditions, partial deprotection of the phosphoryl group was found to be also possible. When 2n in THF was treated with a solution of NH₃/MeOH at room temperature, the N-protected 1,4-amino alcohol 4n was isolated in 85% yield as a result of controlled double methanolysis of the phosphoryl diester without affecting the phosphoryl amide linkage.

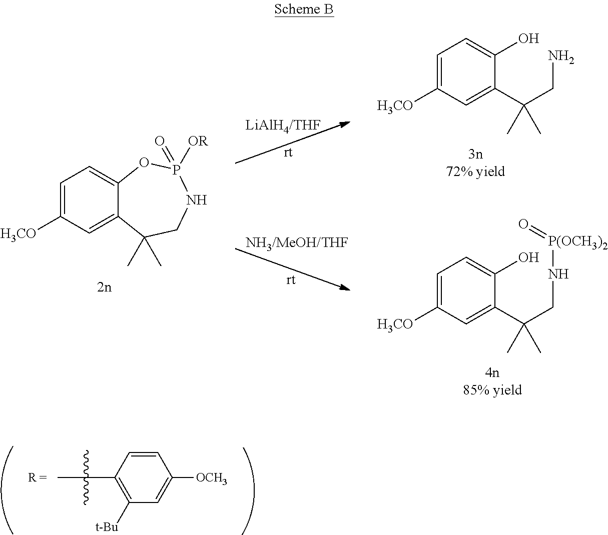

In summary, a Co(II)-based catalytic system has been established for the highly effective intramolecular C—H amination of phosphoryl azides, producing a wide range of cyclophosphoramidates in high yields with nitrogen gas as the only byproduct. In addition to its neutral and non-oxidative conditions, this new catalytic system is highlighted with features such as amination of primary C—H bonds and formation of 7-membered ring structures. Further studies are underway to render the catalytic system stereoselective.

TABLE 1
Intramolecular Nitrene C—H Bond Insertion of 2,4,6-Phosphoryl Azide 1a
Catalyzed by Co(II) Complexes of Different Porphyrins.^{a}

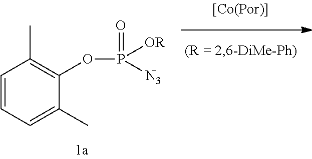

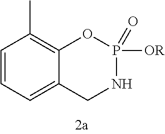

| entry | [Co(Por)] | yield (%)^{b} |
|---|---|---|
| 1 | [Co(TPP)]^{c} | 0% |
| 2 | [Co(P1)] | 79% |
| 3 | [Co(P2)] | 98% |
| 4 | [Co(P3)] | 96% |
| 5 | [Co(P4)] | <5%^{d} |
| 6 | [Co(P5)] | 0% |

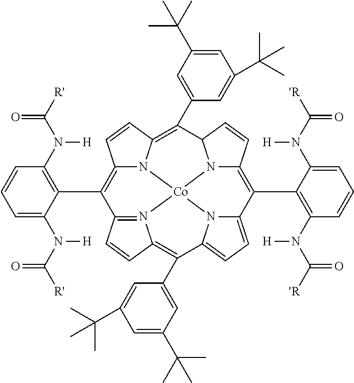

R′ = i-Pr: [Co(P1)]
(P1: 3,5-Di^{t}Bu-IbuPhyrin)
R′ = Me: [Co(P2)]
(P2: 3,5-Di^{t}Bu-AcePhyrin)
R′ = Et: [Co(P3)]
(P3: 3,5-Di^{t}Bu-ProPhyrin)
R′ = t-Bu: [Co(P4)]
(P4: 3,5-Di^{t}Bu-PivPhyrin)
R′ = Ph: [Co(P5)]
(P5: 3,5-Di^{t}Bu-PhePhyrin)
^{a}Performed with 2 mol % of [Co(Por)] for 12 h in PhCF₃ at 80° C. under N₂ in the presence of 4 Å MS; [1a] = 0.10 M.
^{b}Isolated yields.
^{c}TPP = tetraphenylporphyrin.
^{d}Trace amount product.

TABLE 2
[Co(TPP)]-Catalyzed Intramolecular C—H Amination

| entry | azide | R | cyclophosphoramidate | yield (%)^{b} |
|---|---|---|---|---|
| 1 2 | 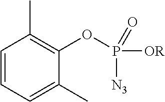 1a | 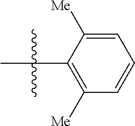 | 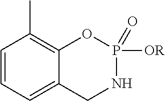 2a | 99 94^{d} |
| 3 4 | 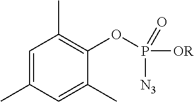 1b | 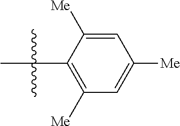 | 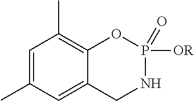 2b | 92 99^{d} |
| 5 | 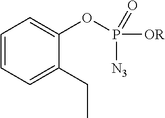 1c | Et | 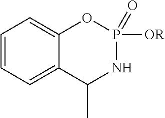 2c | 94^{c,d,f,g} |
| 6 | 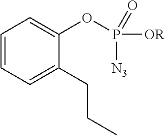 1d | Et | 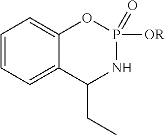 2d | 90^{c,d,h} |
| 7 | 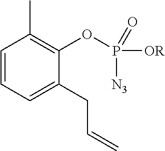 1e | 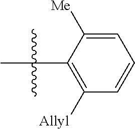 | 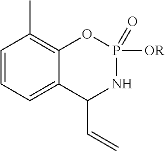 2e | 74^{c,e,i} |
| 8 | 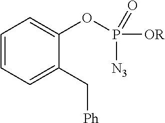 1f | 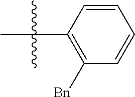 | 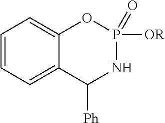 2f | 83^{c,e,i} |
| 9 | 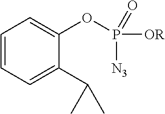 1g | 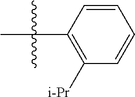 | 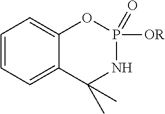 2g | 85^{e} |
| 10 11 | 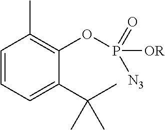 1h | 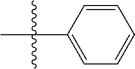 | 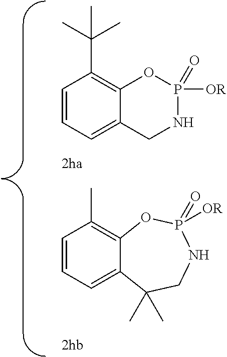 | 90%^{d} $\frac{2 ha}{2 hb} = \frac{84}{16}$ 96%^{e} $\frac{2 ha}{2 hb} = \frac{76}{24}$ |
| 12 | 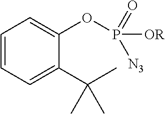 1i | 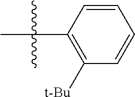 | 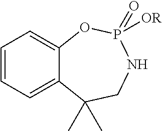 2i | 96 |
| 13 14 15 | 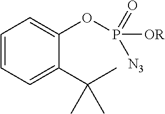 1j | 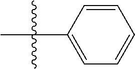 | 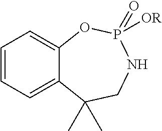 2j | 55 85^{e} 97^{d} |
| 16 17 | 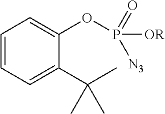 1k | Et | 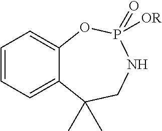 2k | 37 95^{d} |
| 18 | 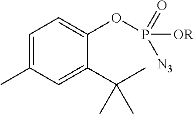 1l | 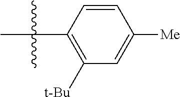 | 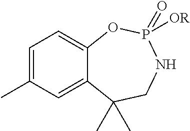 2l | 99 |
| 19 | 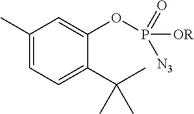 1m | 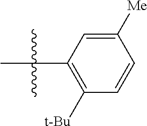 | 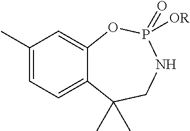 2m | 99 |
| 20 | 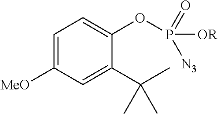 1n | 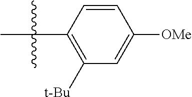 | 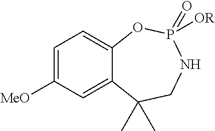 2n | 97 |
| 21 | 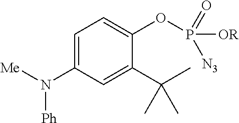 1o | 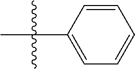 | 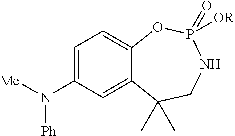 2o | 80^{d,k} |
| 22 | 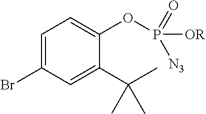 1p | Et | 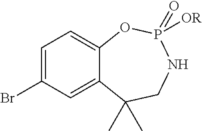 2p | 70^{d,k} |

^{a}Performed with 1 mol % of [Co(P2)] for 24 h in PhCF₃ at 80° C. under N₂ in the presence of 4Å MS; [1] = 0.10 M.
^{b}Isolated yields.
^{c}NMR yields.
^{d}2 mol % of [Co(P1)].
^{e}2 mol % of [Co(P2)].
^{f}60° C.
^{g}dr: 65/35.
^{h}dr: 55/45.
ⁱdr: 53/47.
^{j}dr: 91/9.
^{k}Partial decomposition during purification; yield would be higher.

TABLE S1
Intramolecular Nitrene C—H Bond Insertion of Phosphoryl
Azide 1a Catalyzed by Cobalt(II) Complexes of Porphyrins.^{a}

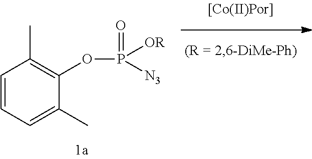

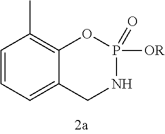

| entry | [Co(Por)]^{b} | mol(%) | solvent | time | yield(%)^{c} |
|---|---|---|---|---|---|
| 1 | [Co(TPP)] | 2.0 | PhCl | 48 | 0 |
| 2 | [Co(P1)] | 2.0 | PhCl | 48 | 85 |
| 3 | [Co(P1)] | 2.0 | PhCF₃ | 48 | 99 |
| 4 | [Co(P1)] | 2.0 | CH₂Cl₂ | 48 | 99 |
| 5 | [Co(P1)] | 2.0 | Hexane | 48 | 99 |
| 6 | [Co(P1)] | 2.0 | MeCO₂Et | 48 | 68 |
| 7 | [Co(P1)] | 2.0 | MeCN | 48 | 30 |
| 8 | [Co(P1)] | 2.0 | PhCF₃ | 12 | 48^{d} |
| 9 | [Co(P1)] | 2.0 | CH₂Cl₂ | 12 | 8^{d} |
| 10 | [Co(P1)] | 2.0 | Hexane | 12 | 37^{d} |
| 11 | [Co(P1)] | 1.0 | PhCF₃ | 48 | 98 |
| 12 | [Co(P1)] | 2.0 | PhCF₃ | 24 | 94 |
| 13 | [Co(P1)] | 2.0 | PhCF₃ | 12 | 79 |
| 14 | [Co(P2)] | 2.0 | PhCF₃ | 12 | 98 |
| 15 | [Co(P2)] | 1.0 | PhCF₃ | 24 | 99 |

^{a}Performed at 80° C. under N₂ in presence of 4 Å molecular sieves with [1a] = 0.10 M.
^{b}see Table 1.
^{c}Isolated yeidls.
^{d}60° C.

### Example 2

General Considerations. All cross-coupling and C—H amination reactions were performed under nitrogen in oven-dried glassware following standard Schlenk techniques. 4 Åmolecular sieves were dried in a vacuum oven prior to use. 1,4-Dioxane was distilled under nitrogen from sodium benzophenone ketyl prior to use. Anhydrous PhCF₃ was purchased from Sigma-Aldrich and used without further purification. Thin layer chromatography was performed on Merck TLC plates (silica gel 60 F254). Flash column chromatography was performed with ICN silica gel (60 Å, 230-400 mesh, 32-63 μm). ¹H NMR and ¹³C NMR were recorded on a Varian Inova400 (400 MHz) or a Bruker 250 (250 MHz) instrument with chemical shifts reported relative to residual solvent. ³¹P NMR were recorded on a Varian Inova400 (400 MHz) instrument. Infrared spectra were measured with a Nicolet Avatar 320 spectrometer with a Smart Miracle accessory. HRMS data was obtained on an Agilent 1100 LC/MS/TOF mass spectrometer.

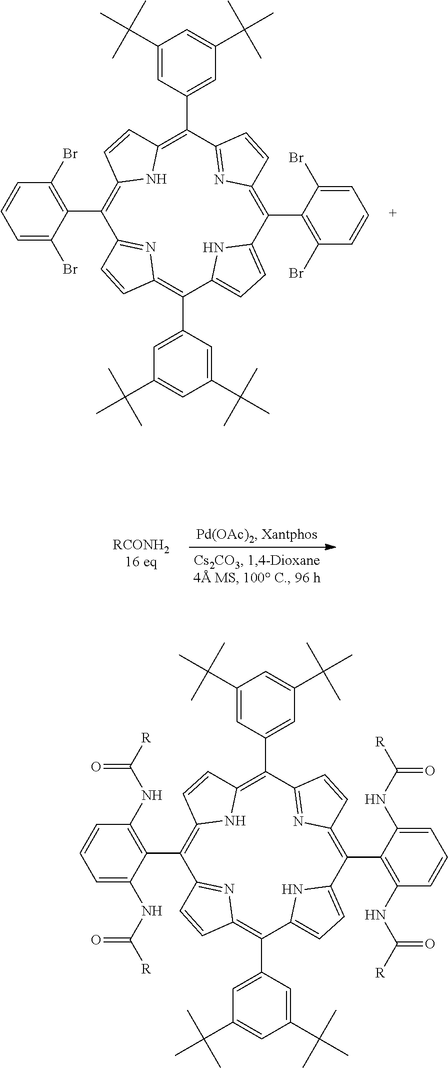

General Procedure for Synthesis of Porphyrins. An oven-dried Schlenk tube equipped with a stirring bar was degassed on a vacuum line and purged with nitrogen. The tube was then charged with 5,15-Bis(2,6-dibromophenyl)-10,20-bis[3,5-di (tert-butyl)phenyl]porphyrin¹ (0.2 mmol, 1 eq), amide (3.2 mmol, 16 eq), Pd(OAc)₂ (0.08 mmol, 40%), Xantphos (0.16 mmol, 80%), Cs₂CO₃ (3.2 mmol, 16 eq). The tube was capped with a Teflon screw cap, evacuated, and backfilled with nitrogen. After the Teflon screw cap was replaced with a rubber septum, 1,4-dioxane (10 mL) was added via syringe. The tube was purged with nitrogen (1-2 mins) and the septum was then replaced with the Teflon screw cap and sealed. The reaction mixture was heated in an oil bath at 100□ with stirring for 96 hours. The resulting reaction mixture was concentrated and the solid residue was purified by flash chromatography to afford the designed product.

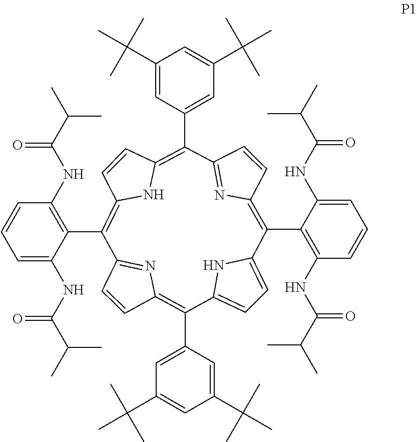

Porphyrin 1 (P1) Purified by chromatography on silica gel (gradient elution: 4:1-42:1 hexanes/EtOAc); purple solid (198.2 mg, 84%): TLC R_{f}=0.56 (1:1 hexanes/EtOAc). ¹H NMR (400 MHz, CDCl₃): δ 8.97 (d, J=4.4 Hz, 4H), 8.85 (d, J=4.8 Hz, 4H), 8.48 (d, J=7.6 Hz, 4H), 8.00 (s, 4H), 7.90-7.85 (m, 4H), 6.46 (s, 4H), 1.52 (s, 36H), 1.20 (m, 4H), 0.31 (d, J=7.4 Hz, 24H), −2.53 (s, 2H). See Chen et al., J. Am. Chem. Soc. 2004, 126, 14718-14719; and Ruppel et al. Org. Lett. 2008, 10, 1995-1998.

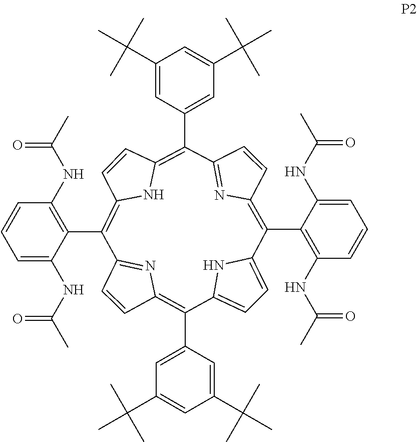

Porphyrin 2 (P2) Purified by chromatography on silica gel (gradient elution: 2:1→0:1 hexanes/EtOAc); purple solid (134.4 mg, 63%): TLC R_{f}=0.24 (1:1 hexanes/EtOAc). ¹H NMR (400 MHz, CDCl₃): δ 9.00 (d, J=4.4 Hz, 4H), 8.82 (s, 4H), 8.48 (br, 4H), 8.06 (s, 4H), 7.87-7.83 (m, 4H), 6.34 (s, 4H), 1.54 (s, 36H), 1.10 (s, 12H)-2.61 (s, 2H). ¹³C NMR (100 MHz, CDCl₃): δ 168.0, 149.4, 139.6, 139.0, 133.8, 133.7, 123.0, 130.5, 130.0, 121.9, 121.6, 117.5, 107.9, 35.1, 31.7, 24.2. UV-vis (CHCl₃), λₘₐₓ, nm (log ε): 419 (5.38), 520 (4.13), 550 (3.70), 590 (3.63), 645 (3.47). HRMS (APCI) Calcd. for C₆₈H₇₅N₈O₄1067.5906. Found 1067.5915.

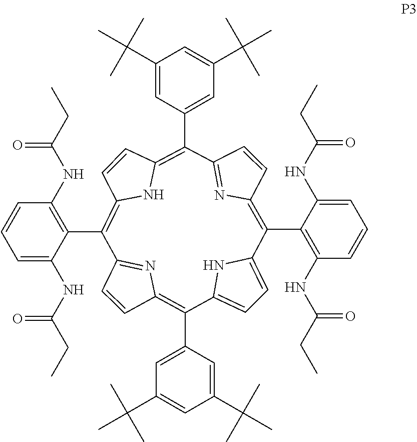

Porphyrin 3 (P3) Purified by chromatography on silica gel (gradient elution: 2:1→0:1 hexanes/EtOAc); purple solid (94.3 mg, 42%): TLC R_{f}=0.40 (1:1 hexanes/EtOAc). ¹H NMR (400 MHz, CDCl₃): δ 9.98 (d, J=4.8 Hz, 4H), 8.81 (d, J=4.8 Hz, 4H), 8.49 (br, 4H), 8.02 (d, J=1.6 Hz, 4H), 7.85 (t, J=8.4 Hz, 2H), 7.84 (s, 2H), 6.37 (br, 4H), 1.52 (s, 36H), 1.24 (s, 8H), 0.30 (s, 12H), −2.59 (s, 2H). ¹³C NMR (62.9 MHz, CDCl₃): δ 171.7, 149.4, 139.7, 138.9, 133.6 (br), 130.5, 130.1, 123.0, 121.9, 117.6 (br), 108.1, 35.1, 31.7, 30.1, 8.9. UV-vis (CHCl₃), λₘₐₓ, nm (log ε): 425 (5.05), 520 (4.08), 555 (3.64), 589 (3.56), 645 (3.41). HRMS (APCI) ([M+H]⁺) Calcd. for C₇₂H₈₃N₈O₄ 1123.6532. Found 1123.6519.

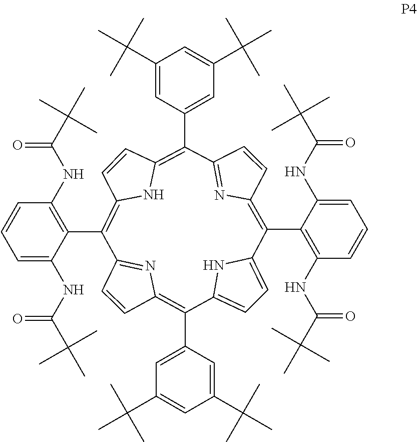

Porphyrin 4 (P4) Purified by chromatography on silica gel (gradient elution: 4:1→2:1 hexanes/EtOAc); purple solid (118.6 mg, 48%): TLC R_{f}=0.68 (1:1 hexanes/EtOAc). ¹H NMR (400 MHz, CDCl₃): δ 8.93 (d, J=4.8 Hz, 4H), 8.82 (d, J=4.4 Hz, 4H), 8.48 (d, J=8.4 Hz, 4H), 7.99 (s, 4H), 7.88-7.84 (m, 4H), 6.93 (s, 4H), 1.53 (s, 36H), 0.12 (s, 36H). −2.47 (s, 2H). ¹³C NMR (62.9 MHz, CDCl₃): δ 176.1, 149.4, 139.8, 138.8, 133.4, 130.5, 130.3, 123.2, 122.1, 121.8, 117.7, 107.9, 39.0, 35.0, 31.6, 26.4. UV-vis (CHCl₃), λₘₐₓ, nm (log ε): 425 (5.10), 520 (4.20), 555 (3.80), 595 (3.71), 650 (3.81). HRMS (APCI) ([M+Na]⁺) Calcd. for C₈₀H₉₈N₈O₄Na 1257.7603. Found 1257.7624.

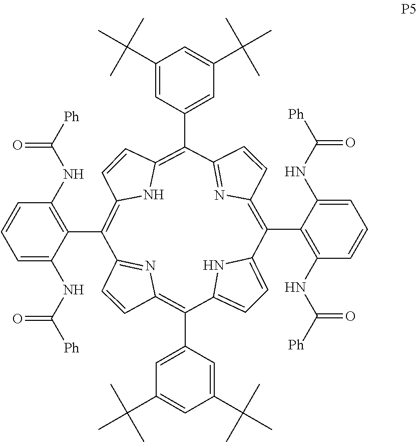

Porphyrin 5 (P5) Purified by chromatography on silica gel (gradient elution: 4:1-2:1 hexanes/EtOAc); purple solid (134.1 mg, 51%): TLC R_{f}=0.60 (1:1 hexanes/EtOAc). ¹H NMR (250 MHz, CDCl₃): δ 8.98 (s, 8H), 8.76 (d, J=8.5 Hz, 4H), 7.99 (t, J=5.8 Hz, 2H), 7.95 (s, 4H), 7.80 (t, J=1.8 Hz, 2H), 7.46 (s, 4H), 6.70-6.73 (m, 4H), 6.47-6.37 (m, 16H), 1.45 (s, 36H), −2.41 (s, 2H). ¹³C NMR (62.9 MHz, CDCl₃): δ 165.2, 149.4, 139.6, 139.1, 134.2, 131.0, 130.2, 127.9, 126.1, 123.4, 121.9, 121.8, 117.4, 107.8, 35.0, 31.6. UV-vis (CHCl₃), λₘₐₓ, nm (log ε): 429 (4.52), 520 (3.94), 555 (3.68), 595 (3.54), 655 (3.58). HRMS (APCI) ([M+H]⁺) Calcd. for C₈₈H₈₃N₈O₄ 1315.6532. Found 1315.6484.

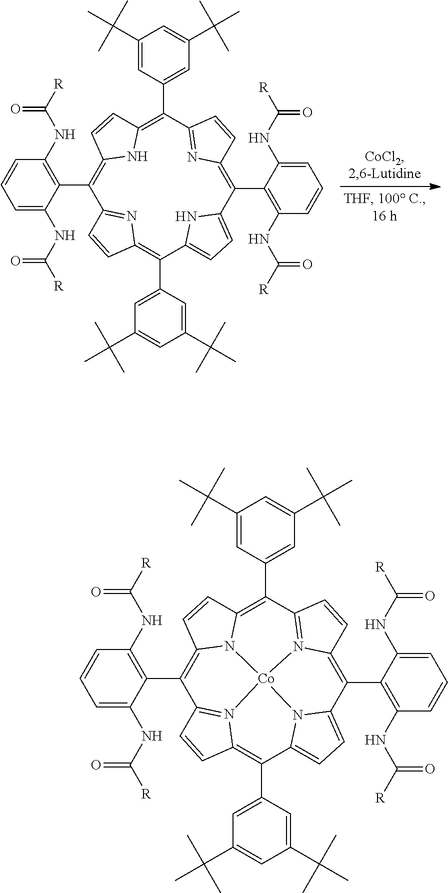

General Procedure for Synthesis of Cobalt Porphyrin Complex. Porphyrin (0.05 mmol) and anhydrous CoCl₂ (0.5 mmol) were placed in an oven-dried, resealable Schlenk tube. The tube was capped with a Teflon screwcap, evacuated, and backfilled with nitrogen. The screw cap was replaced with a rubber septum, dry THF (3-4 mL) and 2,6-lutidine (0.25 mmol) were added via syringe. The tube was purged with nitrogen for 1-2 minutes, and then the septum was replaced with the Teflon screw cap. The tube was sealed, and its contents were heated in an oil bath at 100□ with stirring overnight. The resulting mixture was cooled to room temperature, taken up in ethyl acetate, and transferred to a separatory funnel. The mixture was washed with water 3 times and concentrated. The solid residue was purified by flash chromatography to afford designed product.

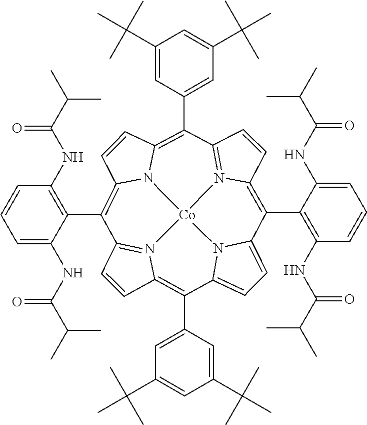

Co(P1)^{1b} Purified by chromatography on silica gel (2:1 hexanes/EtOAc); purple solid (51.9 mg, 84%): TLC R_{f}=0.56 (1:1 hexanes/EtOAc). UV-vis (CHCl₃), λₘₐₓ, nm (log ε): 415 (5.23), 530 (4.19).

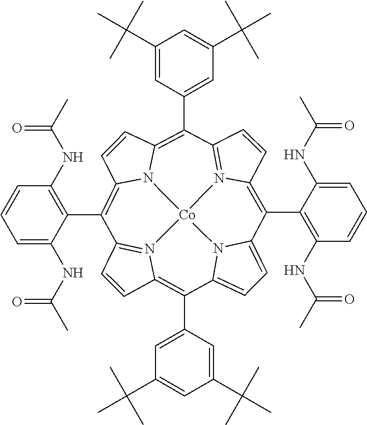

Co(P2) Purified by chromatography on silica gel (1:1 hexanes/EtOAc); purple solid (46.7 mg, 83%): TLC R_{f}=0.24 (1:1 hexanes/EtOAc). UV-vis (CHCl₃), λₘₐₓ, nm (log ε): 415 (5.09), 440 (4.85), 530 (4.03). HRMS (APCI): ([M+H]⁺), Calcd. for C₆₈H₇₃CoN₈O₄ 1124.5081. Found 1124.5064.

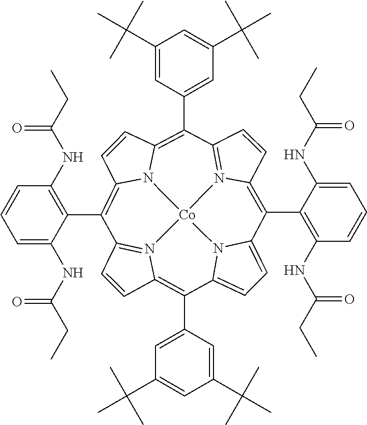

Co(P3) Purified by chromatography on silica gel (1:1 hexanes/EtOAc); purple solid (49.6 mg, 84%%): TLC R_{f}=0.40 (1:1 hexanes/EtOAc). UV-vis (CHCl₃), λₘₐₓ, nm (log ε): 415 (5.15), 440 (4.99), 530 (4.16). HRMS (APCI): ([M+H]⁺), Calcd. for C₇₂H₈₁CoN₈O₄ 1180.5707. Found 1180.5712.

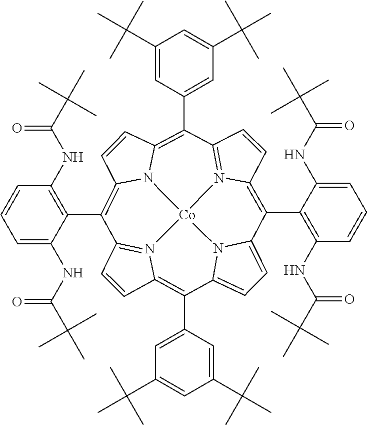

Co(P4) Purified by chromatography on silica gel (2:1 hexanes/EtOAc); purple solid (58.2 mg, 90%): TLC R_{f}=0.68 (1:1 hexanes/EtOAc). UV-vis (CHCl₃), λₘₐₓ, nm (log ε): 415 (5.25), 530 (4.15). HRMS (APCI): ([M+H]⁺), Calcd. for C₈₀H₉₇CoN₈O₄ 1292.6959. Found 1292.6998.

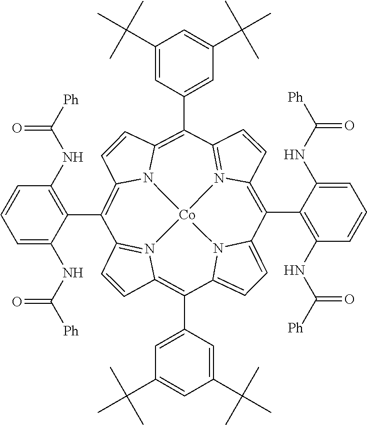

Co(P5) Purified by chromatography on silica gel (2:1 hexanes/EtOAc); purple solid (61.1 mg, 89%): TLC R_{f}=0.60 (1:1 hexanes/EtOAc). UV-vis (CHCl₃), λₘₐₓ, nm (log ε): 420 (5.13), 530 (4.04). HRMS (APCI) ([M+H]⁺) Calcd. for C₈₈H₈₁CoN₈O₄ 1372.5707. Found 1372.5680.

### Example 3

General Procedure for Synthesis of Phosphoryl Azides. A solution of the phosphoryl chloride in acetone (0.2 mol/L) was stirred in a round bottom flask. Sodium azide (1.5 eq) was added in portions to the phosphoryl chloride mixture and the reaction was monitored by TLC to completion (typically 3-5 hrs). After the reaction was completed, the flask underwent rotary evaporation until most of the acetone was removed. The reaction mixture was purified by flash chromatography (hexane:ethyl acetate=10:1). the product was visualized on TLC using UV. The fractions containing product were collected and concentrated by rotary evaporation to afford the compound. Note: Some azides could be explosive and should be handled carefully. Based on DSC experiments (see Page S26, azides 1b and 1m), this type of azides are stable under reaction condition used.

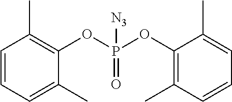

Bis(2,6-dimethylphenyl)phosphorazidate (1a, Table 2, entry 1-2) Purified by chromatography on silica gel (10:1 hexanes/EtOAc); White solid (530 mg, 80%): TLC R_{f}=0.39 (10:1 hexanes/EtOAc). ¹H NMR (400 MHz, CDCl₃): δ 7.05 (s, 6H), 2.36 (s, 12H). ¹³C NMR (62.9 MHz, CDCl₃): δ 147.8 (d, J_{P,C}=9.4 Hz), 130.2 (d, J_{P,C}=3.5 Hz), 129.3 (d, J_{P,C}=1.9 Hz), 125.9 (d, J_{P,C}=2.1 Hz), 17.0. ³¹P NMR (161 MHz, CDCl₃) δ-9.73 (s). IR (neat, cm⁻¹): 2176, 1478, 1290, 1269, 1149, 1089, 967, 949, 789, 764, 754, 661.

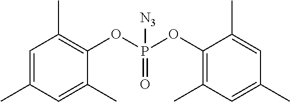

Dimesityl phosphorazidate (1b, Table 2, entry 3-4) Purified by chromatography on silica gel (10:1 hexanes/EtOAc); White solid (596.6 mg, 83%): TLC R_{f}=0.39 (10:1 hexanes/EtOAc). ¹H NMR (400 MHz, CDCl₃): δ 6.84 (s, 4H), 2.31 (s, 12H), 2.24 (s, 6H). ¹³C NMR (100 MHz, CDCl₃): δ 145.7 (d, J_{P,C}=9.4 Hz), 135.3, 129.8, 129.7, 20.6, 16.9. ³¹P NMR (161 MHz, CDCl₃) δ-9.16 (s). IR (neat, cm⁻¹): 2162, 1480, 1294, 1270, 1185, 1119, 969, 947, 924, 769.

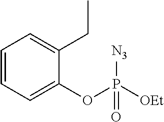

Ethyl 2-ethylphenyl phosphorazidate (1c, Table 2, entry 5) Purified by chromatography on silica gel (10:1 hexanes/EtOAc); colorless liquid (454.3 mg, 89%): TLC R_{f}=0.30 (10:1 hexanes/EtOAc). ¹H NMR (400 MHz, CDCl₃): δ 7.29 (d, J=7.6 Hz, 1H), 7.23 (d, J=7.2 Hz, 1H), 7.20-7.13 (m, 2H), 4.34-4.25 (m, 2H), 2.69 (q, J=7.6 Hz, 2H), 1.40 (t, J=7.2 Hz, 3H), 1.22 (t, J=7.6 Hz, 3H). ¹³C NMR (100 MHz, CDCl₃): δ 148.1 (d, J_{P,C}=7.5 Hz), 135.1 (d, J_{P,C}=6.6 Hz), 129.9, 127.1, 125.8, 119.7, 65.7 (d, J_{P,C}=6.7 Hz), 23.0, 16.0 (d, J_{P,C}=6.5 Hz), 14.1. ³¹P NMR (161 MHz, CDCl₃) δ-4.86 (s). IR (neat, cm⁻¹): 2973, 2162, 1491, 1453, 1269, 1218, 1173, 1117, 1082, 981, 948, 790, 759, 606.

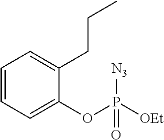

Ethyl 2-propylphenyl phosphorazidate (1d, Table 2, entry 6) Purified by chromatography on silica gel (10:1 hexanes/EtOAc); colorless liquid (457.6 mg, 85%): TLC R_{f}=0.32 (10:1 hexanes/EtOAc). ¹H NMR (400 MHz, CDCl₃): δ 7.29 (d, J=8.0 Hz, 1H). 7.22-7.11 (m, 3H), 4.33-4.25 (m, 2H), 2.62 (t, J=7.6 Hz, 2H), 1.67-1.57 (m, 2H), 1.39 (t, J=7.2 Hz, 3H), 0.94 (t, J=7.2 Hz, 3H). ¹³C NMR (100 MHz, CDCl₃): δ 148.3 (d, J_{P,C}=6.7 Hz), 133.5 (d, J_{P,C}=7.0 Hz), 130.7, 127.2, 125.6, 119.7, 65.6 (d, J_{P,C}=6.4 Hz), 32.0, 23.1, 16.0 (d, J_{P,C}=6.4 Hz), 13.8. ³¹P NMR (161 MHz, CDCl₃) δ-4.95 (s). IR (neat, cm⁻¹): 2962, 2162, 1490, 1452, 1269, 1219, 1173, 1119, 1080, 978, 951, 795, 761.

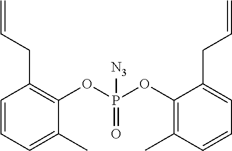

Bis(2-allyl-6-methylphenyl)phosphorazidate (1e, Table 2, entry 7) Purified by chromatography on silica gel (10:1 hexanes/EtOAc); colorless liquid (559.8 mg, 73%): TLC R_{f}=0.42 (10:1 hexanes/EtOAc). ¹H NMR (400 MHz, CDCl₃): δ 7.08 (s, 6H), 5.97-5.86 (m, 2H), 5.10-5.03 (m, 4H), 3.52 (d, J=6.4 Hz, 4H), 2.36 (s, 6H). ¹³C NMR (100 MHz, CDCl₃): δ 147.3 (d, J_{P,C}=9.2 Hz), 135.8, 132.1 (d, J_{P,C}=3.7 Hz), 130.4 (d, J_{P,C}=2.6 Hz), 129.8, 128.5, 126.0, 116.5, 34.4, 17.2 (d, J_{P,C}=7.6 Hz). ³¹P NMR (161 MHz, CDCl₃) δ-9.60 (s). IR (neat, cm⁻¹): 2165, 1465, 1298, 1273, 1256, 1145, 1084, 968, 940, 779, 756.

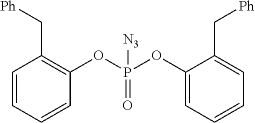

Bis(2-benzylphenyl)phosphorazidate (1f, Table 2, entry 8) Purified by chromatography on silica gel (10:1 hexanes/EtOAc); colorless liquid (692.2 mg, 76%): TLC R_{f}=0.30 (10:1 hexanes/EtOAc). ¹H NMR (400 MHz, CDCl₃): δ 7.34 (d, J=7.6 Hz, 2H), 7.28-7.11 (m, 16H), 3.98 (s, 4H). ¹³C NMR (100 MHz, CDCl₃): 148.2 (d, J_{P,C}=8.0 Hz), 139.3, 132.3 (d, J_{P,C}=6.5 Hz), 131.5, 128.8, 128.4, 127.9, 126.2, 126.1, 120.0, 35.8. ³¹P NMR (161 MHz, CDCl₃) δ-9.62 (s). IR (neat, cm⁻¹): 2167, 1488, 1451, 1300, 1270, 1217, 1163, 1091, 969, 779, 758, 696, 609.

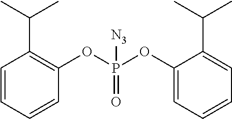

Bis(2-isopropylphenyl)phosphorazidate (1g, Table 2, entry 9) Purified by chromatography on silica gel (10:1 hexanes/EtOAc); colorless liquid (567.9 mg, 79%): TLC R_{f}=0.40 (10:1 hexanes/EtOAc). ¹H NMR (250 MHz, CDCl₃): δ 7.36-7.28 (m, 4H), 7.23-7.16 (m, 4H), 3.27-3.15 (m, 2H), 1.17 (dd, J=2.5, 7.0 Hz, 12H). ¹³C NMR (62.9 MHz, CDCl₃): 147.4 (d, J_{P,C}=8.2 Hz), 139.5 (d, J_{P,C}=6.7 Hz), 127.2, 126.9 (d, J_{P,C}=1.6 Hz), 126.2 (d, J_{P,C}=1.4 Hz), 119.7 (d, J_{P,C}=2.5 Hz), 26.8, 22.8 (d, J_{P,C}=3.8 Hz). ³¹P NMR (161 MHz, CDCl₃) δ-9.84 (s). IR (neat, cm⁻¹): 2964, 2166, 1487, 1448, 1301, 1269, 1217, 1168, 1079, 968, 786, 756, 609.

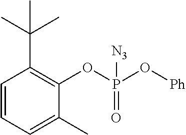

2-tert-Butyl-6-methylphenyl phenyl phosphorazidate (1h, Table 2, entry 10, 11) Purified by chromatography on silica gel (10:1 hexanes/EtOAc); colorless liquid (559.4 mg, 81%): TLC R_{f}=0.46 (10:1 hexanes/EtOAc). ¹H NMR (400 MHz, CDCl₃): δ. 7.41-7.35 (m, 2H), 7.30-7.23 (m, 4H), 7.10-7.06 (m, 2H), 2.50 (s, 3H), 1.47 (s, 9H). ¹³C NMR (100 MHz, CDCl₃): δ 149.8 (d, J_{P,C}=7.1 Hz), 149.0 (d, J_{P,C}=9.4 Hz), 141.2 (d, J_{P,C}=5.2 Hz), 130.4, 130.2, 130.0, 125.9, 125.6, 120.2, 120.1, 34.9, 30.6, 18.7 (d, J=4.9 Hz). ³¹P NMR (161 MHz, CDCl₃) δ-10.68 (s). IR (neat, cm⁻¹): 2964, 2165, 1490, 1297, 1272, 1196, 1161, 1132, 1100, 964, 940, 777, 688.

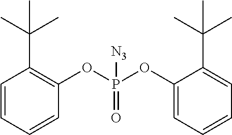

Bis(2-tert-butylphenyl)phosphorazidate (1i, Table 2, entry 12) Purified by chromatography on silica gel (10:1 hexanes/EtOAc); colorless liquid (658.6 mg, 85%): TLC R_{f}=0.46 (10:1 hexanes/EtOAc). ¹H NMR (250 MHz, CDCl₃): δ 7.57 (d, J=8.0 Hz, 2H), 7.41 (d, J=7.5 Hz, 2H), 7.25-7.16 (m, 4H), 1.41 (s, 18H). ¹³C NMR (100 MHz, CDCl₃): δ 149.4 (d, J_{P,C}=6.5 Hz), 139.8 (d, J_{P,C}=8.8 Hz), 127.9, 127.5, 125.4, 119.5, 34.7, 30.0. ³¹P NMR (161 MHz, CDCl₃) δ-11.54 (s). IR (neat, cm⁻¹): 2958, 2166, 1488, 1441, 1174, 1082, 966, 783, 753.

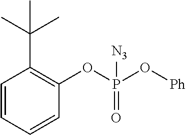

2-tert-Butylphenyl phenyl phosphorazidate (1j, Table 2, entry 13-15) Purified by chromatography on silica gel (10:1 hexanes/EtOAc); colorless liquid (523.4 mg, 79%): TLC R_{f}=0.39 (10:1 hexanes/EtOAc). ¹H NMR (400 MHz, CDCl₃): δ 7.53 (d, J=8.0 Hz, 1H), 7.41-7.36 (m, 3H), 7.29-7.20 (m, 4H), 7.17 (t, J=7.6 Hz, 1H), 1.38 (s, 9H). ¹³C NMR (100 MHz, CDCl₃): δ 149.7 (d, J=7.3 Hz), 149.5 (d, J_{P,C}=7.3 Hz), 139.8 (d, J_{P,C}=8.3 Hz), 130.0, 127.9, 127.5, 126.1, 125.4, 120.3 (d, J_{P,C}=4.4 Hz), 119.5, 34.6, 30.0. ³¹P NMR (161 MHz, CDCl₃) δ-10.54 (s). IR (neat, cm⁻¹): 2962, 2166, 1488, 1442, 1301, 1270, 1199, 1177, 1161, 1087, 962, 942, 782, 755, 688.

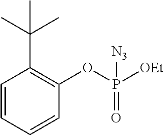

2-tert-Butylphenyl ethyl phosphorazidate (1k, Table 2, entry 16-17) Purified by chromatography on silica gel (10:1 hexanes/EtOAc); colorless liquid (504.2 mg, 89%): TLC R_{f}=0.35 (10:1 hexanes/EtOAc). ¹H NMR (400 MHz, CDCl₃): δ 7.42 (d, J=8.0 Hz, 1H), 7.35 (d, J=7.6 Hz, 1H), 7.18 (t, J=7.6 Hz, 1H), 7.10 (t, J=7.6 Hz, 1H), 4.37-4.28 (m, 2H), 1.40 (t, J=7.2 Hz, 3H), 1.38 (s, 9H). ¹³C NMR (100 MHz, CDCl₃): δ 149.5 (d, J_{P,C}=7.1 Hz), 139.7 (d, J_{P,C}=8.5 Hz), 127.7, 127.4, 125.1, 119.4, 65.6 (d, J_{P,C}=6.1 Hz), 34.6, 30.0, 16.0 (d, J_{P,C}=6.2 Hz). ³¹P NMR (161 MHz, CDCl₃) δ-5.74 (s). IR (neat, cm⁻¹): 2964, 2162, 1489, 1442, 1297, 1268, 1191, 1089, 1028, 947, 794, 773, 756.

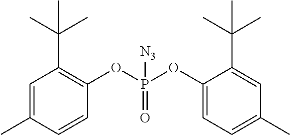

Bis(2-tert-butyl-4-methylphenyl)phosphorazidate (1l, Table 2, entry 18) Purified by chromatography on silica gel (10:1 hexanes/EtOAc); white solid (739.6 mg, 89%): TLC R_{f}=0.49 (10:1 hexanes/EtOAc). ¹H NMR (400 MHz, CDCl₃): δ 7.43 (d, J=8.0 Hz, 2H), 7.19 (s, 2H), 7.02 (d, J=8.4 Hz, 2H), 2.33 (s, 6H), 1.40 (s, 18H). ¹³C NMR (100 MHz, CDCl₃): δ 147.3 (d, J_{P,C}=6.5 Hz), 139.4 (d, J_{P,C}=8.5 Hz), 134.8, 128.6, 127.8, 119.3, 34.6, 30.1, 21.0. ³¹P NMR (161 MHz, CDCl₃) δ-11.28 (s). IR (neat, cm⁻¹): 2961, 2164, 1490, 1262, 1171, 1082, 968, 814, 764.

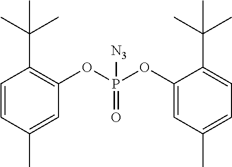

Bis(2-tert-butyl-5-methylphenyl)phosphorazidate (1m, Table 2, entry 19) Purified by chromatography on silica gel (10:1 hexanes/EtOAc); white solid (664.8 mg, 80%): TLC R_{f}=0.49 (10:1 hexanes/EtOAc). ¹H NMR (400 MHz, CDCl₃): δ 7.39 (s, 2H), 7.27 (dd, J=1.6, 8.0 Hz, 2H), 6.96 (d, J=8.0 Hz, 2H), 2.32 (s, 6H), 1.39 (s, 18H). ¹³C NMR (100 MHz, CDCl₃): δ 149.2 (d, J_{P,C}=7.3 Hz), 137.6, 136.6 (d, J_{P,C}=8.7 Hz), 127.6, 126.0, 120.1, 34.4, 30.1, 20.7. ³¹P NMR (161 MHz, CDCl₃) δ-11.83 (s). IR (neat, cm⁻¹): 2960, 2164, 1505, 1304, 1270, 1230, 1163, 1145, 1068, 1010, 976, 898, 815, 761, 611.

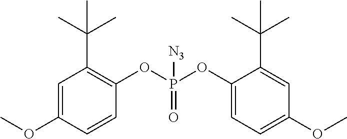

Bis(2-tert-butyl-4-methoxyphenyl)phosphorazidate (1n, Table 2, entry 20) Purified by chromatography on silica gel (10:1 hexanes/EtOAc); white solid (760.8 mg, 85%): TLC R_{f}=0.20 (10:1 hexanes/EtOAc). ¹H NMR (400 MHz, CDCl₃): δ 7.47 (d, J=8.8 Hz, 2H), 6.93 (dd, J=1.6, 2.4 Hz, 2H), 6.70 (dd, J=2.8, 8.8 Hz, 2H), 3.78 (s, 6H), 1.37 (s, 18H). ¹³C NMR (100 MHz, CDCl₃): δ 156.5, 143.1 (d, J_{P,C}=6.5 Hz), 141.3 (d, J_{P,C}=8.6 Hz), 120.1, 114.8, 110.5, 55.5, 34.8, 29.9. ³¹P NMR (161 MHz, CDCl₃) δ-10.88 (s). IR (neat, cm⁻¹): 2967, 2163, 1578, 1483, 1294, 1263, 1166, 1048, 960, 875, 823, 764.

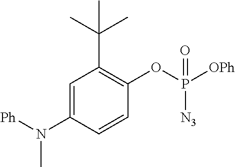

2-tert-Butyl-4-(N-methyl-N-phenylamino)phenyl phosphorazidate (1o, Table 2, entry 21) Purified by chromatography on silica gel (10:1 hexanes/EtOAc); colorless solid (750.2 mg, 86%): TLC R_{f}=0.32 (10:1 hexanes/EtOAc). ¹H NMR (250 MHz, CDCl₃): δ 7.37-7.28 (m, 3H), 7.23-7.15 (m, 5H), 7.00 (dd, J=1.8, 2.8 Hz, 1H), 6.92-6.77 (m, 4H), 3.22 (s, 3H), 1.26 (s, 9H). ¹³C NMR (62.9 MHz, CDCl₃): δ 149.8 (d, J_{P,C}=7.7 Hz), 148.8, 146.1, 144.1 (d, J_{P,C} 7.7 Hz), 140.8 (d, J_{P,C}=8.6 Hz), 130.0 (d, J_{P,C}=1.1 Hz), 129.1, 126.1 (d, J_{P,C}=1.6 Hz), 121.0, 120.8, 120.3 (d, J_{P,C}=4.8 Hz), 120.2 (d, J_{P,C}=2.3 Hz), 119.6, 119.3, 40.4, 34.8, 30.0. ³¹P NMR (161 MHz, CDCl₃) δ-10.3 (s). IR (neat, cm⁻¹): 2167, 1593, 1489, 1268, 1200, 1180, 1162, 1080, 966, 753.

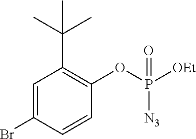

4-bromo-2-tert-Butylphenyl ethyl phosphorazidate (1p, Table 2, entry 22) Purified by chromatography on silica gel (10:1 hexanes/EtOAc); colorless liquid (543.0 mg, 75%): TLC R_{f}=0.28 (10:1 hexanes/EtOAc). ¹H NMR (400 MHz, CDCl₃): δ 7.44 (s, 1H), 7.34-7.26 (m, 2H), 4.35-4.27 (m, 2H), 1.39 (t, J=8.0 Hz, 3H), 1.34 (s, 9H). ¹³C NMR (62.9 MHz, CDCl₃): δ 148.5 (d, J_{P,C}=7.3 Hz), 142.1 (d, J_{P,C}=8.7 Hz), 130.9, 130.1, 121.0 (d, J_{P,C}=2.3 Hz), 118.2, 65.8 (d, J=6.4 Hz), 34.8, 29.7, 16.0 (d, J_{P,C}=6.6 Hz). ³¹P NMR (161 MHz, CDCl₃) δ-5.65 (s). IR (neat, cm⁻¹): 2164, 1483, 1267, 1197, 1085, 1029, 947, 854, 784.

### Example 4

General Procedure for C—H Amination. An oven dried Schlenk tube, that was previously evacuated and backfilled with nitrogen gas, was charged with catalyst (0.002 mmol), and 4 Å MS (100 mg). The Schlenk tube was then evacuated and back filled with nitrogen. The Teflon screw cap was replaced with a rubber septum and then an approximately 0.5 ml portion of PhCF₃ was added, then azide (0.2 mmol), followed by the remaining PhCF₃ (total 2 mL). The Schlenk tube was then purged with nitrogen for 2 minutes and the rubber septum was replaced with a Teflon screw cap. The Schlenk tube was then placed in an oil bath for the desired time and temperature. Following completion of the reaction, the reaction mixture was purified by flash chromatography. The fractions containing product were collected and concentrated by rotary evaporation to afford the compound.

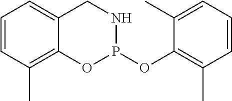

2a (Table 2, entry 1-2) Purified by chromatography on silica gel (1:1 hexanes/EtOAc); white solid (56.9 mg, 99%): TLC R_{f}=0.36 (1:1 hexanes/EtOAc). ¹H NMR (400 MHz, CDCl₃): δ 7.13 (d, J=7.6 Hz, 1H), 7.02-6.95 (m, 4H), 6.90 (d, J=7.6 Hz, 1H), 4.46-4.39 (m, 1H), 4.26-4.12 (m, 2H), 2.36 (s, 6H), 2.31 (s, 3H). ¹³C NMR (62.9 MHz, CDCl₃): δ 149.8 (d, J=7.8 Hz), 148.6 (d, J_{P,C}=8.6 Hz), 130.1 (d, J_{P,C}=3.3 Hz), 128.9 (d, J_{P,C}=1.7 Hz), 128.0 (d, J_{P,C}=7.5 Hz), 124.9 (d, J_{P,C}=1.9 Hz), 123.9, 123.7, 123.5, 123.3, 43.3 (d, J_{P,C}=3.1 Hz), 17.1, 15.6. ³¹P NMR (161 MHz, CDCl₃) δ-1.08 (s). IR (neat, cm⁻¹): 3238, 1469, 1261, 1168, 1088, 983, 780, 761, 721, 651. HRMS (ESI) ([M+H]⁺) Calcd. for C₁₆H₁₉NO₃P: 304.1097. Found: 304.1089.

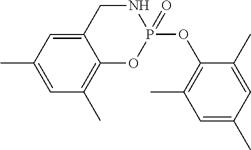

2b (Table 2, entry 3-4) Purified by chromatography on silica gel (1:1 hexanes/EtOAc); white solid (65.6 mg, 99%): TLC R_{f}=0.36 (1:1 hexanes/EtOAc). ¹H NMR (400 MHz, CDCl₃): δ 6.89 (s, 1H), 6.77 (s, 2H), 6.65 (s, 1H), 4.60-4.53 (m, 1H), 4.30 (dt, J=16, 4.8 Hz, 1H), 4.13-4.00 (m, 1H), 2.28 (s, 6H), 2.24 (d, J=1.6 Hz, 6H), 2.21 (s, 3H). ¹³C NMR (100 MHz, CDCl₃): δ 147.6 (d, J_{P,C}=7.4 Hz), 146.4 (d, J_{P,C}=8.4 Hz), 134.1, 132.6, 130.5, 129.7, 129.4, 127.5 (d, J_{P,C}=7.9 Hz), 124.3, 123.2 (d, J_{P,C}=9.2 Hz), 43.2, 20.5 (d, J_{P,C}=4.0 Hz), 17.0, 15.5. ³¹P NMR (161 MHz, CDCl₃) δ-0.41 (s). IR (neat, cm⁻¹): 3161, 1478, 1264, 1248, 1188, 1133, 967, 933, 904, 848, 710. HRMS (ESI) ([M+H]⁺) Calcd. for C₁₈H₂₃NO₃P 332.1410. Found 332.1409.

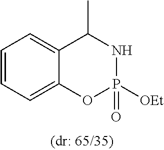

2c (Table 2, entry 5) was obtained using the general procedure in 94% yield, determined by mixture NMR. ¹H NMR (250 MHz, CDCl₃): δ 7.24-6.97 (m, 4H), 4.57-4.52 (m, 1H), 4.20-4.07 (m, 2H), 3.60 (br, 0.35), 3.20 (br, 0.65), 1.56 (dd, J=2.5, 6.8 Hz, 1.95H), 1.52 (d, J=7 Hz, 1.05H), 1.32-1.26 (m, 3H). ¹³C NMR (62.9 MHz, CDCl₃): δ 150.7 (d, J_{P,C}=6.9 Hz), 150.0 (d, J_{P,C}=7.0 Hz), 128.7, 128.6, 128.5 (d, J_{P,C}=1.6 Hz), 128.3, 128.2, 126.5, 125.6, 123.8, 123.7, 119.2 (d, J_{P,C}=5.1 Hz), 119.1 (d, J_{P,C}=5.2 Hz), 63.0 (d, J_{P,C}=5.3 Hz), 50.3 (d, J_{P,C}=2.6 Hz), 49.2 (d, J_{P,C}=2.3 Hz), 24.3 (d, J_{P,C}=1.9 Hz), 22.3 (d, J_{P,C}=10.4 Hz), 16.2 (d, J_{P,C}=1.6 Hz), 16.1 (d, J_{P,C}=1.5 Hz). ³¹P NMR (161 MHz, CDCl₃) δ 2.44 (s), 2.23 (s). IR (neat, cm⁻¹): 3207, 2979, 1487, 1448, 1311, 1249, 1217, 1082, 928, 804, 757. HRMS (APCI) ([M+H]⁺) Calcd. for C₁₀H₁₅NO₃P 228.0784. Found 228.0786.

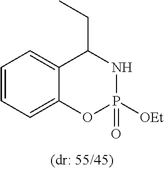

2d (Table 2, entry 6) was obtained using the general procedure in 90% yield, determined by mixture NMR. ¹H NMR (400 MHz, CDCl₃): δ 7.22-7.18 (m, 1H), 7.09-6.99 (m, 3H), 4.39-4.31 (m, 0.45H), 4.22-4.04 (m, 2.55H), 3.80 (t, J=6.8 Hz, 0.55H), 3.31 (br, 0.45H), 1.98-1.73 (m, 2H), 1.33 (t, J=6.8 Hz, 1.65H), 1.26 (t, J=7.2 Hz, 1.35H), 1.02 (t, J=7.2 Hz, 1.65H), 0.98 (t, J=7.2 Hz, 1.35H). ¹³C NMR (100 MHz, CDCl₃): δ 150.9 (d, J_{P,C}=7.1 Hz), 150.1 (d, J_{P,C}=6.5 Hz), 128.7, 128.5, 127.8 (d, J_{P,C}=10.2 Hz), 127.1, 126.9, 126.4, 123.9, 123.5, 119.4, 119.3, 119.2, 63.2 (d, J_{P,C}=5.5 Hz), 63.1 (d, J_{P,C}=5.0 Hz), 56.9, 55.7, 30.5, 29.9 (d, J_{P,C}=6.4 Hz), 16.2 (d, J=7.0 Hz), 10.7, 9.2. ³¹P NMR (161 MHz, CDCl₃) δ 2.51 (s). IR (neat, cm⁻¹): 3176, 2926, 2854, 1453, 1263, 1241, 1218, 1041, 934, 891, 771, 744. HRMS ((APCI)) ([M+H]⁺) Calcd. for C₁₁H₁₇NO₃P 242.0941. Found 242.0948.

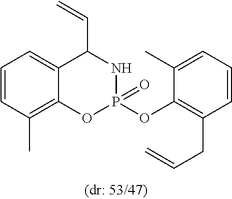

2e (Table 2, entry 7) was obtained using the general procedure in 74% yield, determined by mixture NMR. Major isomer: ¹H NMR (400 MHz, CDCl₃): δ 7.14 (d, J=7.2 Hz, 1H), 7.07-6.95 (m, 5H), 6.01-5.89 (m, 2H), 5.46-5.36 (m, 2H), 5.06-4.98 (m, 3H), 3.50 (d, J=6.4 Hz, 2H), 3.40-3.37 (m, 1H), 2.37 (s, 3H), 2.31 (s, 3H). ¹³C NMR (100 MHz, CDCl₃): δ 148.9, 137.0, 136.9, 136.4, 131.8, 130.7, 130.2, 129:6, 128.1, 125.2, 124.5, 123.6, 119.1, 116.3, 57.7, 34.8, 17.4, 15.8. ³¹P NMR (161 MHz, CDCl₃) δ-4.40 (s). IR (neat, cm⁻¹): 2962, 2924, 1465, 1262, 1239, 1162, 1081, 1032, 958, 803. HRMS (ESI) ([M+H]⁺) Calcd. for C₂₀H₂₃NO₃P 356.1410. Found 356.1415. Minor isomer: ¹H NMR (400 MHz, CDCl₃): δ 7.13 (d, J=7.6 Hz, 1H), 7.04-6.90 (m, 5H), 6.09-5.89 (m, 2H), 5.19-5.00 (m, 4H), 4.89-4.81 (m, 1H), 4.28-4.23 (m, 1H), 3.49 (d, J=6.4 Hz, 2H), 2.36 (s, 3H), 2.31 (s, 3H). ¹³C NMR (100 MHz, CDCl₃): δ 148.7 (d, J=8.0 Hz), 148.4 (d, J=7.8 Hz), 138.4, 136.3, 131.9, 130.4, 130.2, 129.4, 128.4, 128.3, 127.9, 125.1, 123.6, 116.6, 116.2, 57.8, 34.9, 17.6 (d, J=6.0 Hz), 15.7 (d, J_{P,C}=6.1 Hz). ³¹P NMR (161 MHz, CDCl₃) δ-2.41 (s). IR (neat, cm⁻¹): 1464, 1255, 1198, 1162, 1081, 933, 781, 756. HRMS (ESI) ([M+H]⁺) Calcd. for C₂₀H₂₃NO₃P 356.1410. Found 356.1407.

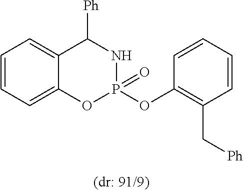

2f (Table 2, entry 8) was obtained using the general procedure in 83% yield, determined by mixture NMR. Major isomer: ¹H NMR (400 MHz, CDCl₃): δ 7.30-6.94 (m, 17H), 6.74 (d, J=7.6 Hz, 1H), 5.59 (dd, J=3.6, 14.4 Hz, 1H), 3.71 (d, J=2.0 Hz, 2H), 3.66-3.62 (m, 1H). ¹³C NMR (100 MHz, CDCl₃): δ 150.0 (d, J_{P,C}=7.8 Hz), 149.3 (d, J_{P,C}=6.9 Hz), 141.3 (d, J_{P,C}=3.7 Hz), 139.9, 131.9 (d, J_{P,C}=7.2 Hz), 131.0, 129.3, 128.9, 128.8, 128.5, 128.4, 128.3, 128.1, 127.6, 125.9, 124.9, 124.4, 120.0, 119.4 (d, J_{P,C}=7.8 Hz), 58.8, 35.9. ³¹P NMR (161 MHz, CDCl₃) δ-5.11 (s). IR (neat, cm⁻¹): 2920, 2850, 1600, 1552, 1295, 1264, 1095, 733, 698. HRMS (ESI) ([M+H]⁺) Calcd. for C₂₆H₂₃NO₃P 428.1410. Found 428.1409. Minor isomer: ¹H NMR (400 MHz, CDCl₃): δ 7.47-6.94 (m, 17H), 6.61 (d, J=7.6 Hz, 1H), 5.21 (s, 1H), 3.87 (s, 2H), 3.32 (d, J=8.0 Hz, 1H). ³¹P NMR (161 MHz, CDCl₃) δ-6.16 (s). IR (neat, cm⁻¹): 2924, 2852, 1602, 1488, 1277, 1215, 1173, 1098, 757, 698. HRMS (ESI) ([M+Na]⁺) Calcd. For C₂₆H₂₂NO₃PNa 450.1230. Found 450.1227.

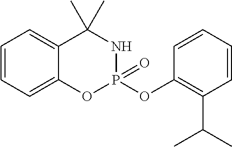

2g (Table 2, entry 9) Purified by chromatography on silica gel (1:1 hexanes/EtOAc); colorless liquid (56.3 mg, 85%): TLC R_{f}=0.50 (1:1 hexanes/EtOAc). ¹H NMR (400 MHz, CDCl₃): δ 7.39 (d, J=7.6 Hz, 1H), 7.25-7.19 (m, 3H), 7.14-7.08 (m, 3H), 7.02 (d, J=8.0 Hz, 1H), 3.99 (d, J_{P,H}=8.8 Hz, 1H), 3.17-3.09 (m, 1H), 1.63 (d, J=2.8 Hz, 3H), 1.61 (s, 3H), 1.11 (d, J=6.8 Hz, 3H), 1.07 (d, J=6.8 Hz, 3H). ¹³C NMR (100 MHz, CDCl₃): δ 149.1 (d, J=7.4 Hz), 148.4 (d, J_{P,C}=7.2 Hz), 139.1 (d, J_{P,C}=6.1 Hz), 131.8 (d, J_{P,C}=8.7 Hz), 128.7, 126.6 (d, J_{P,C}=6.1 Hz), 125.4, 124.9, 124.4, 119.8, 119.6 (d, J_{P,C}=8.6 Hz), 56.4, 32.4 (d, J=9.8 Hz), 32.1, 26.8, 22.8 (d, J=9.8 Hz). ³¹P NMR (161 MHz, CDCl₃) δ-4.26 (s). IR (neat, cm⁻¹): 3199, 2964, 1487, 1447, 1266, 1206, 1179, 1083, 1038, 930, 795, 753. HRMS (ESI) ([M+Na]⁺) Calcd. for C₁₈H₂₂NO₃P 354.1230. Found 354.1235.

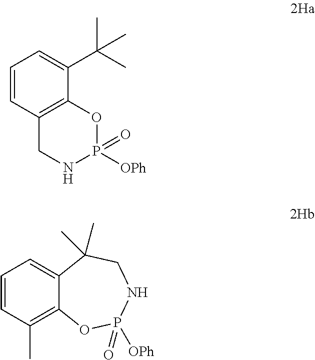

2h (2Ha/2Hb=76/24) (Table 2, entry 10-11) Purified by chromatography on silica gel (1:1 hexanes/EtOAc); colorless liquid (60.9 mg, 96%): TLC R_{f}=0.36 (1:1 hexanes/EtOAc). ¹H NMR (400 MHz, CDCl₃): δ 7.31-7.11 (m, 6H), 7.04-6.95 (m, 1.24H), 6.88 (d, J=6.8 Hz, 0.76H), 4.36-4.25 (m, 1.76H), 4.17-4.03 (m, 0.76H), 3.46-3.37 (m, 0.24H), 2.86-2.73 (m, 0.24H), 2.25 (s, 0.72H), 1.38 (s, 6.84H), 1.34 (s, 0.72H), 1.26 (s, 0.72H). ¹³C NMR (62.9 MHz, CDCl₃): δ 150.8 (d, J_{P,C}=6.9 Hz), 150.6 (d, J_{P,C}=7.3 Hz), 150.1 (d, J_{P,C}=8.3 Hz), 146.1 (d, J_{P,C}=7.3 Hz), 139.8 (d, J_{P,C}=6.8 Hz), 136.8 (d, J_{P,C}=2.3 Hz), 131.7 (d, J_{P,C}=5.2 Hz), 129.6, 129.5 (d, J_{P,C}=1.9 Hz), 126.8 (d, J_{P,C}=1.8 Hz), 126.3, 125.2, 125.1, 125.0 (d, J_{P,C}=1.3 Hz), 124.9, 124.8 (d, J_{P,C}=1.2 Hz), 124.5 (d, J_{P,C}=0.9 Hz), 123.5, 120.6 (d, J_{P,C}=4.7 Hz), 120.5 (d, J_{P,C}=4.7 Hz), 52.4 (d, J_{P,C}=1.7 Hz), 43.7 (d, J_{P,C}=3.0 Hz), 40.8, 34.8, 29.9, 29.1, 28.0, 17.4. ³¹P NMR (161 MHz, CDCl₃) δ 2.19 (s, 2Hb), −1.55 (s, 2Ha). IR (neat, cm⁻¹): 3239, 2964, 1489, 1436, 1265, 1207, 1174, 933, 778, 785, 690. HRMS (ESI) ([M+1]⁺) Calcd. for C₁₇H₂₁NO₃P: 318.1254. Found 318.1243.

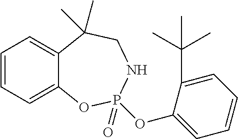

2i (Table 2, entry 12) Purified by chromatography on silica gel (1:1 hexanes/EtOAc); white solid (69.0 mg, 96%): TLC R_{f}=0.34 (1:1 hexanes/EtOAc). ¹H NMR (250 MHz, CDCl₃): δ 7.62 (d, J=8.0 Hz, 1H), 7.33-7.02 (m, 7H), 4.45-4.31 (m, 1H), 3.57-3.44 (m, 1H), 2.98-2.77 (m, 1H), 1.35 (s, 3H), 1.29 (s, 3H), 1.28 (s, 9H). ¹³C NMR (62.9 MHz, CDCl₃): δ 150.2 (d, J_{P,C}=6.3 Hz), 147.4 (d, J_{P,C}=7.1 Hz), 139.2 (d, J_{P,C}=8.7 Hz), 137.1 (d, J_{P,C}=2.1 Hz), 129.1 (d, J_{P,C}=1.6 Hz), 128.1, 127.2 (d, J_{P,C}=7.1 Hz), 125.7 (d, J_{P,C}=1.5 Hz), 124.0, 123.4 (d, J_{P,C}=5.4 Hz), 119.3 (d, J_{P,C}=2.7 Hz), 51.9, 40.8, 34.5, 29.8, 28.8, 27.5. ³¹P NMR (161 MHz, CDCl₃) δ 0.96 (s). IR (neat, cm⁻¹): 3258, 2961, 2923, 1486, 1440, 1253, 1187, 1089, 937, 754. HRMS (ESI) ([M+Na]⁺) Calcd. for C₂₀H₂₆NO₃PNa: 382.1543. Found 382.1547.

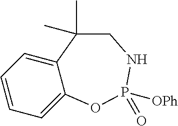

2j (Table 2, entry 13-15) Purified by chromatography on silica gel (1:1 hexanes/EtOAc); white solid (58.8 mg, 97%): TLC R_{f}=0.34 (1:1 hexanes/EtOAc). ¹H NMR (400 MHz, CDCl₃): δ 7.32-7.03 (m, 9H), 4.21-4.13 (m, 1H), 3.47-3.38 (m, 1H), 2.88-2.74 (m, 1H), 1.32 (s, 3H), 1.26 (s, 3H). ¹³C NMR (100 MHz, CDCl₃): δ 150.8 (d, J_{P,C}=6.6 Hz), 147.2 (d, J_{P,C}=6.4 Hz), 136.9, 129.6, 129.3, 128.1, 125.7, 124.9, 123.3 (d, J_{P,C}=5.0 Hz), 120.3 (d, J_{P,C}=4.6 Hz), 52.3, 40.8, 28.9, 27.9. ³¹P NMR (161 MHz, CDCl₃) δ 2.54 (s). IR (neat, cm⁻¹): 2921, 2851, 1487, 1463, 1441, 1244, 1184, 1009, 934, 770, 690. HRMS (ESI) ([M+H]⁺) Calcd. for C₁₆H₁₉NO₃P 304.1097. Found 304.1096.

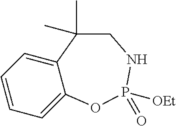

2k (Table 2, entry 16-17) Purified by chromatography on silica gel (1:1 hexanes/EtOAc); white solid (48.5 mg, 95%): TLC R_{f}=0.28 (1:1 hexanes/EtOAc). ¹H NMR (400 MHz, CDCl₃): δ 7.30 (dd, J=1.6, 7.6 Hz, 1H), 7.19-7.04 (m, 3H), 4.22-4.12 (m, 2H), 3.62 (br, 1H), 3.40 (dt, J=9.6, 14.8 Hz, 1H), 2.92-2.79 (m, 1H), 1.34 (s, 3H), 1.32 (t, J=6.8 Hz, 3H), 1.27 (s, 3H). ¹³C NMR (100 MHz, CDCl₃): δ. 147.5 (d, J_{P,C}=7.1 Hz), 137.0, 129.3, 128.1, 125.4, 123.1 (d, J=4.5 Hz), 63.1 (d, J_{P,C}=5.1 Hz), 52.3, 40.8, 28.9, 28.0, 16.1 (d, J_{P,C}=5.0 Hz). ³¹P NMR (161 MHz, CDCl₃) δ 7.63 (s). IR (neat, cm⁻¹): 3232, 1487, 1436, 1246, 1203, 1110, 1036, 973, 935, 922, 847, 771. HRMS (ESI) ([M+Na]⁺) Calcd. for C₁₂H₁₈NO₃PNa 278.0917. Found. 278.0932.

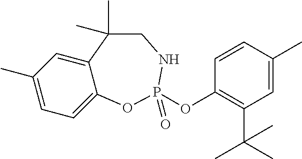

2l (Table 2, entry 18) Purified by chromatography on silica gel (1:1 hexanes/EtOAc); white solid (76.8 mg, 99%): TLC R_{f}=0.36 (1:1 hexanes/EtOAc). ¹H NMR (400 MHz, CDCl₃): δ 7.46 (d, J=8.4 Hz, 1H), 7.07 (d, J=8.8 Hz, 2H), 7.00-6.93 (m, 2H), 6.89 (dd, J=1.6, 8.0 Hz, 1H), 4.71-4.62 (m, 1H), 3.49-3.40 (m, 1H), 2.88-2.74 (m, 1H), 2.29 (s, 3H), 2.27 (s, 3H), 1.26 (s, 12H), 1.24 (s, 3H). ¹³C NMR (100 MHz, CDCl₃): δ 148.0 (d, J=6.3 Hz), 145.2 (d, J=6.8 Hz), 138.9 (d, J_{P,C}=8.1 Hz), 136.6, 134.9, 133.0, 129.5, 128.6, 127.9, 127.4, 123.1 (d, J_{PC}=4.9 Hz), 119.2, 52.0, 40.6, 34.4, 29.9, 28.8, 27.6, 20.9. ³¹P NMR (161 MHz, CDCl₃) δ 1.96 (s). IR (neat, cm⁻¹): 3206, 1494, 1258, 1178, 931, 906, 825. HRMS (ESI) ([M+H]⁺) Calcd. for C₂₂H₃₁NO₃P 388.2036. Found 388.2036.

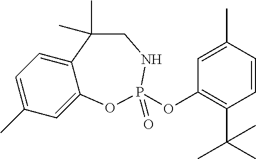

2m (Table 2, entry 19) Purified by chromatography on silica gel (1:1 hexanes/EtOAc); white solid (76.8 mg, 99%): TLC R_{f}=0.36 (1:1 hexanes/EtOAc). ¹H NMR (400 MHz, CDCl₃): δ 7.41 (s, 1H), 7.16 (d, J=8.0 Hz, 2H), 6.94 (d, J=7.2 Hz, 1H), 6.93 (s, 1H), 6.84 (d, J=8.0 Hz, 1H), 4.64-4.56 (m, 1H), 3.49-3.40 (m, 1H), 2.89-2.75 (m, 1H), 2.27 (s, 3H), 2.25 (s, 3H), 1.28 (s, 3H), 1.25 (s, 9H), 1.23 (s, 3H). ¹³C NMR (100 MHz, CDCl₃): δ 150.0 (d, J=5.9 Hz), 147.0 (d, J_{P,C}=6.6 Hz), 138.1, 137.0, 136.2 (d, J_{P,C}=8.5 Hz), 134.0, 128.9, 126.9, 126.4, 124.5, 123.7 (d, J_{P,C}=4.9 Hz), 120.0, 51.9, 40.4, 34.2, 29.9, 28.8, 27.6, 20.7, 20.4. ³¹P NMR (161 MHz, CDCl₃) δ 1.56 (s). IR (neat, cm⁻¹): 3234, 2964, 1503, 1405, 1242, 1159, 1076, 1011, 966, 883, 815, 756, 731. HRMS (ESI) ([M+Na]⁺) Calcd. for C₂₂H₃₀NO₃PNa 410.1856. Found 410.1856.

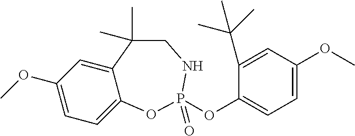

2n (Table 2, entry 20) Purified by chromatography on silica gel (1:1 hexanes/EtOAc); white solid (81.4 mg, 97%): TLC R_{f}=0.28 (1:1 hexanes/EtOAc). ¹H NMR (400 MHz, CDCl₃): δ 7.49 (d, J=8.8 Hz, 1H), 7.01 (dd, J=1.2, 8.8 Hz, 1H), 6.84 (d, J=2.0 Hz, 1H), 6.79 (d, J=2.8 Hz, 1H), 6.68 (dd, J=2.8, 8.8 Hz, 1H), 6.61 (dd, J=2.8, 8.8), 4.51-4.42 (m, 1H), 3.75 (s, 3H), 3.74 (s, 3H), 3.49-3.40 (m, 1H), 2.89-2.75 (m, 1H), 1.29 (s, 3H), 1.25 (s, 9H), 1.24 (s, 3H). ¹³C NMR (100 MHz, CDCl₃): δ 156.9, 155.5, 144.0 (d, J_{P,C}=6.2 Hz), 141.2 (d, J_{P,C}=6.5 Hz), 140.8 (d, J_{P,C}=8.3 Hz) 138.3, 124.0 (d, J_{P,C}=5.1 Hz), 119.9, 115.0, 114.2, 112.3, 110.2, 55.6, 55.5, 51.8, 40.8, 34.6, 29.7, 28.7, 27.5. ³¹P NMR (161 MHz, CDCl₃) δ 2.04 (s). IR (neat, cm⁻¹): 1486, 1280, 1263, 1190, 1176, 1108, 1050, 1040, 939, 898, 888, 880, 820. HRMS (ESI) ([M+H]⁺) Calcd. for C₂₂H₃₁NO₅P 420.1934. Found 420.1942.

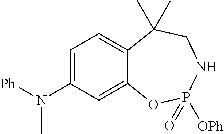

2o (Table 2, entry 21) Purified by chromatography on silica gel (1:1 hexanes/EtOAc); yellow solid (65.3 mg, 80%): TLC R_{f}=0.45 (1:1 hexanes/EtOAc). ¹H NMR (400 MHz, CDCl₃): δ 7.34-7.13 (m, 7H), 7.01-6.84 (m, 6H), 4.06-3.98 (m, 1H), 3.49-3.40 (m, 1H), 3.26 (s, 3H), 2.86-2.73 (m, 1H), 1.31 (s, 3H), 1.20 (s, 3H). ¹³C NMR (100 MHz, CDCl₃): δ. 150.8 (d, J_{P,C}=6.5 Hz), 148.9, 146.5, 142.0 (d, J_{P,C}=6.7 Hz), 137.5, 129.6, 129.1, 124.9, 124.0 (d, J_{P,C}=5.0 Hz), 122.7, 121.6, 120.5, 120.4, 118.7, 52.3, 41.0, 40.3, 28.9, 28.1. ³¹P NMR (161 MHz, CDCl₃) δ 3.21 (s). IR (neat, cm⁻¹): 1594, 1488, 1258, 1188, 927, 907, 731, 690. HRMS (ESI) ([M+H]⁺) Calcd. for C₂₃H₂₆N₂O₃P 409.1676. Found. 409.1667.

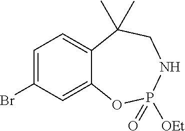

2p (Table 2, entry 22) Purified by chromatography on silica gel (1:1 hexanes/EtOAc); colorless solid (46.8 mg, 70%): TLC R_{f}=0.26 (1:1 hexanes/EtOAc). ¹H NMR (250 MHz, CDCl₃): δ 7.40 (d, J=4.0 Hz, 1H), 7.30-7.25 (m, 1H), 6.93 (dd, J=2.3, 13.6 Hz, 1H), 4.23-4.09 (m, 2H), 3.74 (br, 1H), 3.44-3.29 (m, 1H), 2.93-2.73 (m, 1H), 1.35-1.28 (m, 6H), 1.25 (s, 3H). ¹³C NMR (62.9 MHz, CDCl₃): δ. 146.8 (d, J_{P,C}=6.9 Hz), 139.4 (d, J_{P,C}=2.1 Hz), 132.2 (d, J_{P,C}=1.6 Hz), 131.1, 125.0 (d, J_{P,C}=5.2 Hz), 118.5 (d, J_{P,C}=2.1 Hz), 63.4 (d, J_{P,C}=5.5 Hz), 52.0, 41.0, 28.8, 27.8, 16.1 (d, J_{PC}=6.9 Hz). ³¹P NMR (161 MHz, CDCl₃) δ 7.24 (s). IR (neat, cm⁻¹): 1483, 1453, 1244, 1204, 1107, 1032, 974, 938, 918, 856, 837, 796. HRMS (ESI) ([M+H]⁺) Calcd. for C₁₂H₁₈BrNO₃P 334.0202. Found. 334.0198.

### Example 5

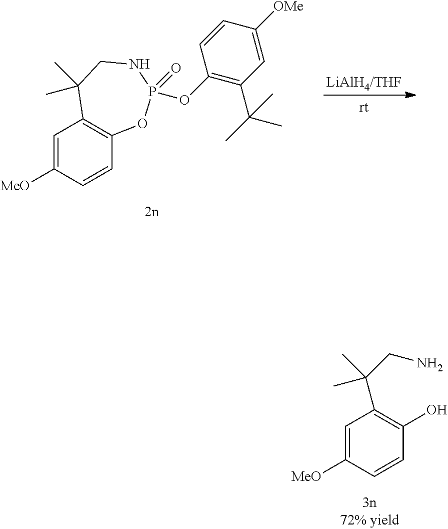

Experimental Procedure for Preparation of Amino Alcohol 3n The cyclophosphoramidates 2n (41.9 mg, 0.1 mmol) was treated with lithium aluminium hydride (16 mg, 0.4 mmol) in dry THF (5 ml) at 0° C. The mixture was stirred for 10 h at room temperature, then quenched with 0.02 mL H₂O, 0.02 mL NaOH (15% aqueous solution) and finally 0.1 mL of H₂O. The mixture was stirred for additional 1h, then was filtered over celite and washed with Et₂O (10 mL). The organic phase is collected and dried over Na₂SO₄. Evaporation of the solvent under reduced pressure. After column chromatography on silica gel (gradient elution: 50:2:1→0:50:1 DCM/MeOH/Et₃N), the product 3n was obtained as a white solid (13.8 mg, 72%): TLC R_{f}=0.5 (35:25:1 DCM/MeOH/Et₃N). ¹H NMR (250 MHz, CDCl₃): δ 6.80 (d, J=5.0 Hz, 1H), 6.77 (s, 1H), 6.66 (dd, J=3.0, 8.8 Hz, 1H), 4.93 (br, 3H), 3.73 (s, 3H), 2.91 (s, 2H), 1.38 (s, 6H). ¹³C NMR (62.9 MHz, CDCl₃): 152.2, 150.9, 134.6, 119.0, 113.9, 111.7, 55.8, 52.9, 39.6, 25.9. IR (neat, cm⁻¹): 3341, 2954, 1466, 1410, 1280, 1211, 1042, 1022, 809, 759. HRMS (ESI) ([M+H]⁺) Calcd. for C₁₁H₁₈NO₂ 196.1332. Found. 196.1336.

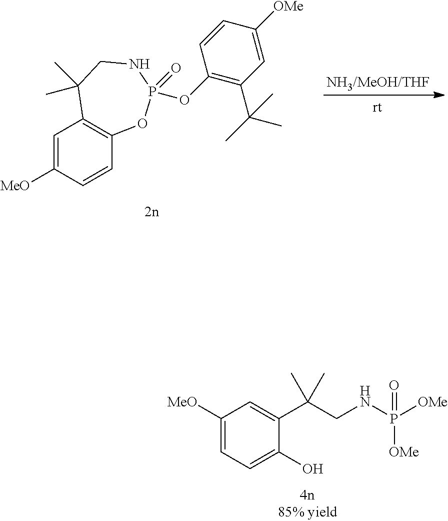

Experimental Procedure for Preparation N-Protected Amino Alcohol 4n. The cyclophosphoramidates 2n (20.9 mg, 0.05 mmol) was added to 5 M NH₃/MeOH (1 ml) and THF (1 ml). The solution was stirred for overnight at room temperature, Evaporation of the solvent under reduced pressure. After column chromatography on silica gel (gradient elution: 1:1→0:1 hexanes/EtOAc), the product 4n was obtained as a white solid (12.2 mg, 85%): TLC R_{f}=0.46 (EtOAc). ¹H NMR (250 MHz, CDCl₃): δ 7.40 (br, 1H), 6.76-6.69 (m, 2H), 6.60-6.54 (m, 1H), 3.72 (s, 3H), 3.55 (d, J=11.3 Hz, 6H), 3.31 (t, J=7.0 Hz, 2H), 2.58-2.50 (m, 1H), 1.34 (s, 6H). ¹³C NMR (62.9 MHz, CDCl₃): δ 153.0, 149.1, 132.8, 117.4, 115.5, 111.5, 55.7, 53.0 (d, J_{P,C}=5.5 Hz), 50.3, 39.4 (d, J_{P,C}=7.5 Hz), 26.0. ³¹P NMR (161 MHz, CDCl₃) δ 13.1 (s). IR (neat, cm⁻¹): 1422, 1289, 1210, 1103, 1028, 877, 831, 759. HRMS (ESI) ([M+Na]⁺) Calcd. for C₁₃H₂₂NO₅PNa 326.1128. Found. 326.1126.

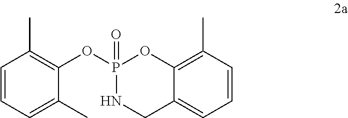

X-ray Crystallography for compound 2a. The X-ray diffraction data were collected using Bruker-AXS SMART-APEXII CCD diffractometer (CuKα, λ=1.54178 Å). Indexing was performed using SMART v5.625 [2]. Frames were integrated with SaintPlus 6.01 [3] software package. Absorption correction was performed by multi-scan method implemented in SADABS [4]. The structure was solved using SHELXS-97 and refined using SHELXL-97 contained in SHELXTL v6.10 [5] and WinGX v1.70.01 [6,7,8] programs packages. All non-hydrogen atoms, were refined anisotropically. Hydrogen atoms were placed in geometrically calculated positions or found in the Fourier difference map (H1) and included in the refinement process using riding model. Crystal data and refinement conditions are shown in Table S2.
[2] Bruker (2001). SMART-V5.625. Data Collection Software.
[3] Bruker (2001b). SAINT-V6.28A. Data Reduction Software.
[4] Sheldrick, G. M. (1996). SADABS. Program for Empirical Absorption Correction. University of Gottingen, Germany.
[5] Sheldrick, G. M. SHELXTL, v. 6.10; Bruker Analytical X-ray, Madison, 2000.
[6] Farrugia L. J. Appl. Cryst. (1999). 32, 837±838
[7] Sheldrick, G. M. (1997) SHELXL-97. Program for the Refinement of Crystal
[8] Sheldrick, G. M. (1990) Acta Cryst. A46, 467-473

TABLE S2
Crystal data and structure refinement for compound 2a.

| | |
|---|---|
| Empirical formula | C16 H18 N O3 P |
| Formula weight | 303.28 |
| Temperature | 100(2) K |
| Wavelength | 1.54178 A |
| Crystal system, space group | Triclinic, P-1 |
| Unit cell dimensions | a = 8.1176(7) A alpha = 86.804(6) |
| | deg. |
| | b = 8.2044(7) A beta = 88.979(5) |
| Volume | deg. |
| Z, Calculated density | c = 11.2871(9) A gamma = 76.988(5) |
| Absorption coefficient | deg. |
| F(000) | 731.27(11) A\hat{ }3 |
| Crystal size | 2, 1.377 Mg/m\hat{ }3 |
| Theta range for data collection | 1.755 mm\hat{ }−1 |
| Limiting indices | 320 |
| Reflection collected/unique | 0.10 × 0.10 × 0.03 mm |
| Completeness to theta = 67.56 | 3.92 to 63.66 deg. |
| Absorption correction | −9 < = h < = 9, −8 < = k < = 9, |
| | −13 < = l < =13 |
| Max. and min. transmission | 5704/2287 [R(int) = 0.0367] |
| Refinement method | 95.0% |
| Data/restraints/parameters | Semi-empirical from equivalents |
| Goodness-of-fit on F\hat{ }2 | 0.9492 and 0.8441 |
| Final R indices [l>2sigma(I)] | Full-matrix least-squares on F\hat{ }2 |
| R indices (all data) | 2287/0/190 |
| Largest diff. peak and hole | 1.078 |
| | R1 = 0.0471, wR2 = 0.1131 |
| | R1= 0.0596, wR2 = 0.1198 |
| | 0.305 and −0.332 e.A\hat{ }−3 |

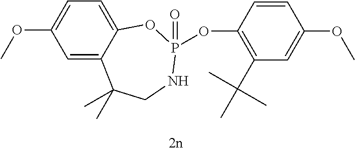

X-ray Crystallography for compound 2n. The X-ray diffraction data were collected using Bruker-AXS SMART-APEXII CCD diffractometer (CuKα, λ=1.54178 Å). Indexing was performed using SMART v5.625 [2]. Frames were integrated with SaintPlus 6.01 [3] software package. Absorption correction was performed by multi-scan method implemented in SADABS [4]. The structure was solved using SHELXS-97 and refined using SHELXL-97 contained in SHELXTL v6.10 [5] and WinGX v1.70.01 [6,7,8] programs packages. All non-hydrogen atoms were refined anisotropically. Hydrogen atoms were placed in geometrically calculated positions or found in the Fourier difference map (H1N) and included in the refinement process using riding model. Occupancy parameters were refined for atoms of disordered CHCl₃ molecule, resulting with 3 molecules of CHCl₃ per unit cell.

Crystal data and refinement conditions are shown in Table S3.
[2] Bruker-AXS (2001). SMART-V5.625. Data Collection Software. Madison, Wis., USA.
[3] Bruker-AXS (2001). SAINT-V6.28A. Data Reduction Software. Madison, Wis., USA.
[4] Sheldrick, G. M. (1996). SADABS. Program for Empirical Absorption Correction. University of Gottingen, Germany.
[5]Sheldrick, G. M. SHELXTL, v. 6.10; Bruker-AXS Madison, Wis., USA. 2000.
[6] Farrugia L. J. Appl. Cryst. (1999). 32, 837±838
[7] Sheldrick, G. M. (2008). Acta Cryst. A64, 112-122.
[8] Sheldrick, G. M. (1990) Acta Cryst. A46, 467-473

TABLE S3
Crystal data and structure refinement for compound 2n.

| Empirical formula | C22H30NO5P, 0.375(CHCl3) | |
|---|---|---|
| Formula weight | 464.20 | |
| Temperature | 100(2) K | |
| Wavelength | 1.54178 A | |
| Crystal system, space group | Monoclinic, C2/c | |
| Unit cell dimensions | a = 17.2209(2) A | alpha = 90 deg. |
| | b = 11.0759(2) A | beta = 90.108(1) deg. |
| Volume | c = 25.2187(4) A | gamma = 90 deg. |

| | |
|---|---|
| Z, Calculated density | 4810.13(13) A\hat{ }3 |
| Absorption coefficient | 8, 1.282 Mg/m\hat{ }3 |
| F(000) | 2.432 mm\hat{ }−1 |
| Crystal size | 1966 |
| Theta range for data collection | 0.20 × 0.15 × 0.05 mm |
| Limiting indices | 5.06 to 67.56 deg. |
| Reflections collected/unique | −20 <= h <= 20, −13 <= k <= 13, −29 <= |
| Completeness to theta = 67.56 | l <= 30 |
| Absorption correction | 18710/4240 [R(int) = 0.0297] |
| Max. and min. transmission | 97.4% |
| Refinement method | Semi-empirical from equivalents |
| Data/restraints/parameters | 0.8881 and 0.6419 |
| Goodness-of-fit on F\hat{ }2 | Full-matrix least-squares on F\hat{ }2 |
| Final R indices | 4240/0/292 |
| [I > 2sigma(I)] | |
| R indices (all data) | 1.080 |
| Largest diff. peak and hole | R1 = 0.0411, wR2 = 0.1074 |
| | R1 = 0.0446, wR2 = 0.1095 |
| | 0.491 and −0.401 e.A\hat{ }−3 |

What is claimed is:

1. A process for the preparation of a phosphoramidate, the process comprising treating a phosphorylazide with a metal porphyrin complex to catalyze the amination of a C—H bond to form a phosphoramidate having 6 or 7 ring atoms.

2. The process of claim 1 wherein the phosphorylazide corresponds to Formula 1 and the phosphoramidate corresponds to Formula 2 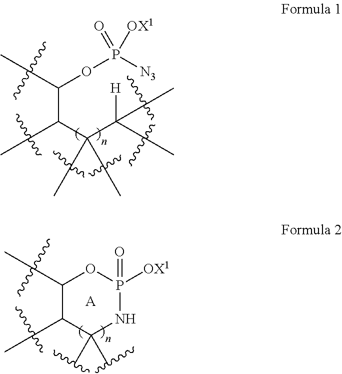
wherein
n is 0 or 1 whereby the A ring of the phosphoramidate of Formula 2 is a 6-membered ring when n is 0 or a 7-membered ring when n is 1, and
X¹ is hydrogen, hydrocarbyl, substituted hydrocarbyl, or heterocyclo.

3. The process of claim 1 wherein the phosphoramidate corresponds to Formula 3 or Formula 4 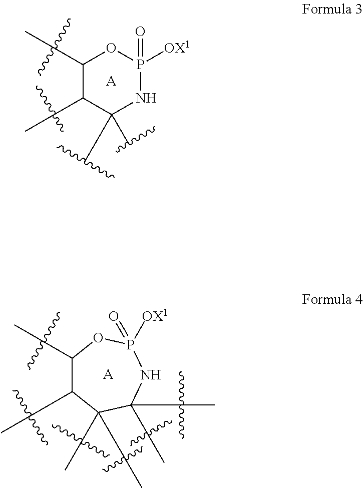
and X¹ is hydrogen, hydrocarbyl, substituted hydrocarbyl, or heterocyclo.

5. The process of claim 1 wherein the phosphoramidate corresponds to Formula 5 or Formula 6 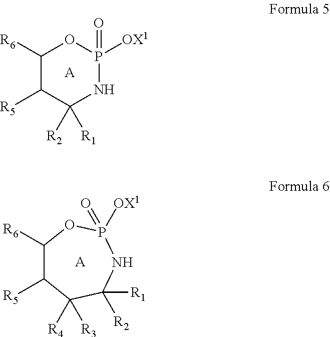
wherein
R₁, R₂, R₃, and R₄ are independently hydrogen, hydrocarbyl, substituted hydrocarbyl, halo, hydroxy, alkoxy, or heterocyclo and
R₅ and R₆ are independently hydrogen, hydrocarbyl, substituted hydrocarbyl, halo, hydroxy, alkoxy, or heterocyclo, or, in combination, form a carbocyclic or heterocyclic ring fused to the A ring of the phosphoramidate of Formula 5 or Formula 6, and
X¹ is hydrogen, hydrocarbyl, substituted hydrocarbyl or heterocyclo.

6. The process of claim 5 wherein the phosphoramidate corresponds to Formula 7 or 8 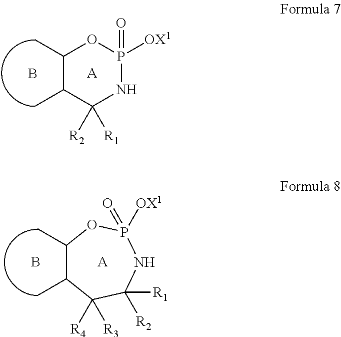
wherein
the B ring is an optionally substituted 5-membered heterocyclic ring or an optionally substituted 6-membered carbocyclic or heterocylic ring, and
X¹ is hydrogen, hydrocarbyl, substituted hydrocarbyl or heterocyclo.

7. The process of claim 6 wherein the B ring is aromatic or heteroaromatic.

8. The process of claim 6 wherein the phosphoramidate is an optionally substituted benzoheterocyclo corresponding to Formula 9 or Formula 10 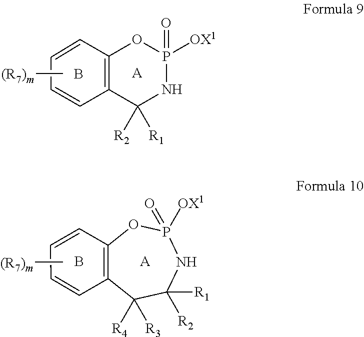
wherein
each R₇ is independently hydrocarbyl, substituted hydrocarbyl, halo, nitro, alkoxy, hydroxy, acyl, acyloxy, or heterocyclo, and
m is 0 to 4.

9. The process of claim 8 wherein the carbon atom of the A ring to which R₁ and R₂ are attached is a spiroatom, and R₁ and R₂ in combination with carbon atom of the A ring to which they are attached define a 5- or 6-membered ring.

10. The process of claim 8 wherein the carbon atom of the A ring to which R₃ and R₄ are attached is a spiroatom and R₃ and R₄ in combination with carbon atom of the A ring to which they are attached define a 5- or 6-membered ring.

11. The process of claim 6 wherein (i) the carbon atom of the A ring to which R₁ and R₂ are attached is a spiroatom and R₁ and R₂ in combination with carbon atom of the A ring to which they are attached define a 5- or 6-membered ring or (ii) the carbon atom of the A ring to which R₃ and R₄ are attached is a spiroatom and R₃ and R₄ in combination with carbon atom of the A ring to which they are attached define a 5- or 6-membered ring.

12. The process of claim 6 wherein B ring is a 5-membered or a 6-membered heterocycle fused to the A ring.

13. The process of claim 12 wherein the B ring is heteroaromatic.

14. The process of claim 12 wherein the B ring is an optionally substituted heterocyclic ring fused to the A ring, the B ring comprising 5 or 6 ring atoms.

15. The process of claim 1 wherein the cobalt porphyrin complex is a chiral Co(II) porphyrin complex corresponding to the structure 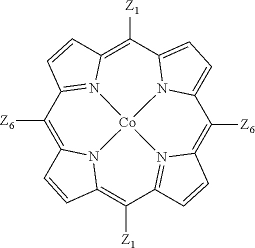
wherein Z₁ is optionally substituted phenyl,
Z₆ is 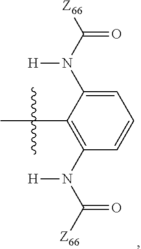
Z₆₆ is hydrocarbyl, substituted hydrocarbyl, or heterocyclo and 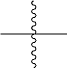
denotes the point of attachment to the porphyrin complex.

16. The process of claim 1 wherein the cobalt porphyrin complex is a chiral Co(II) porphyrin complex corresponding to the structure 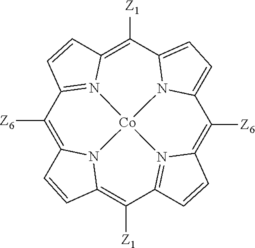
wherein Z₁ is optionally substituted phenyl,
Z₆ is 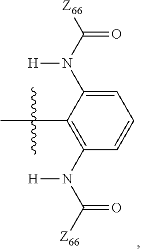
Z₆₆ is alkyl, substituted alkyl, or heterocyclo and 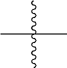
denotes the point of attachment to the porphyrin complex.

17. The process of claim 1 wherein the cobalt porphyrin complex is a chiral Co(II) porphyrin complex corresponding to the structure 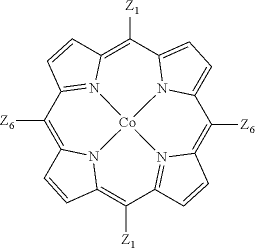
wherein Z₁ is alkyl or alkoxy substituted phenyl,
Z₆ is 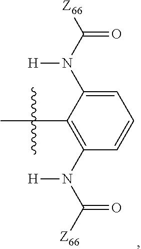
Z₆₆ is lower alkyl and 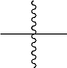
denotes the point of attachment to the porphyrin complex.

18. The process of claim 6 wherein the metal porphyrin complex is an asymmetric cobalt (II) porphyrin complex corresponding to [Co(P1)], [Co(P2)], [Co(P3)], [Co(P4)] or [Co(P5)]:

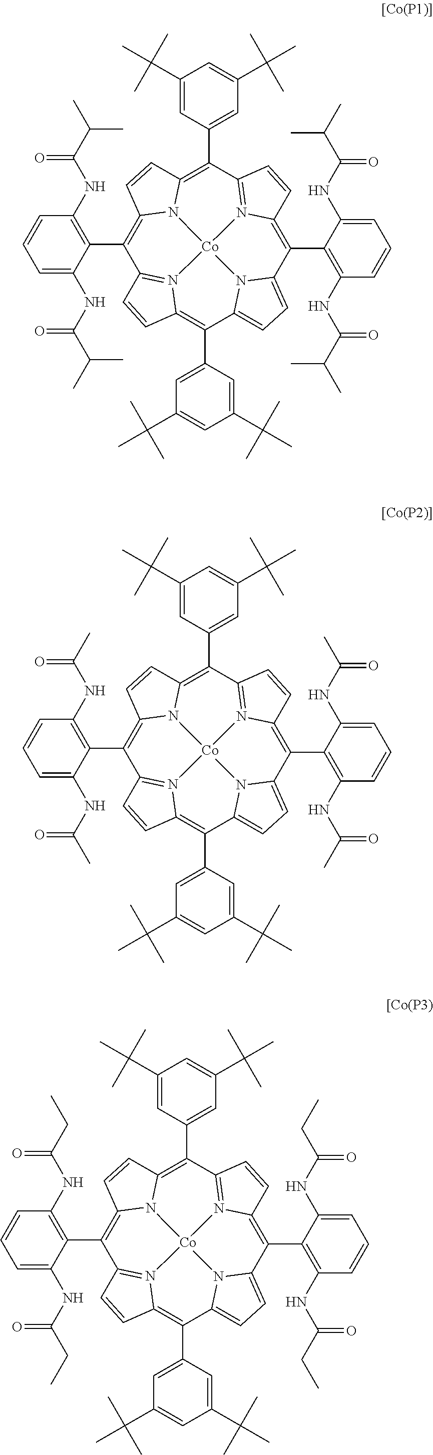

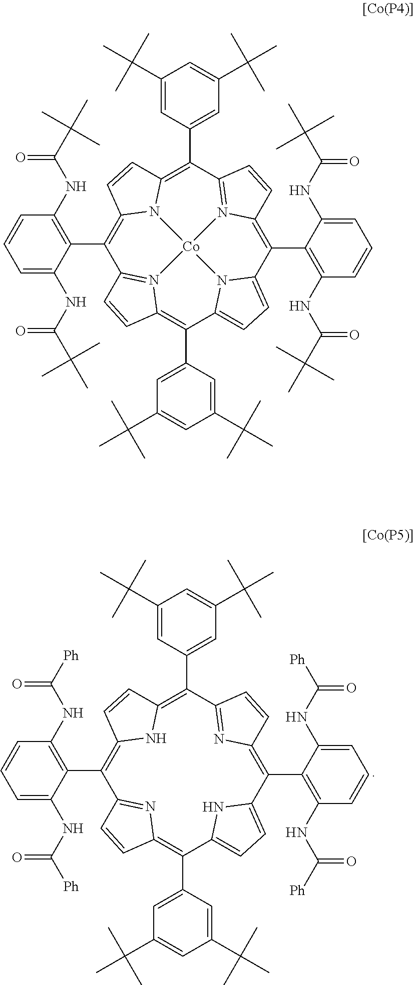

19. The process of claim 2 wherein the metal porphyrin complex is an asymmetric cobalt (II) porphyrin corresponding to the structure 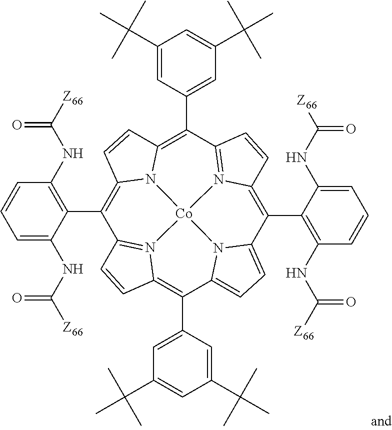
Z₆₆ is methyl, ethyl, isopropyl, or t-butyl.

20. The process of claim 3 wherein the metal porphyrin complex is an asymmetric cobalt (II) porphyrin corresponding to the structure 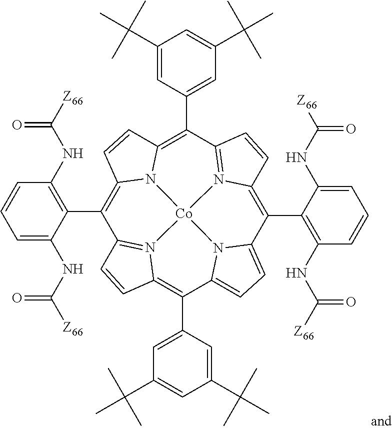
Z₆₆ is methyl, ethyl, isopropyl, or t-butyl.

21. The process of claim 5 wherein the metal porphyrin complex is an asymmetric cobalt (II) porphyrin corresponding to the structure 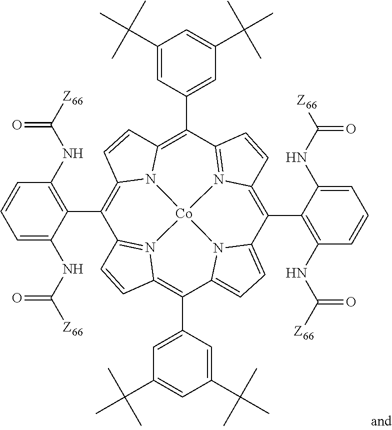
Z₆₆ is methyl, ethyl, isopropyl, or t-butyl.
